(19) United States
(12) Patent Application Publication
(10) Pub. No.: US 2024/0230929 A1
(43) Pub. Date: Jul. 11, 2024

(54) DETECTOR SYSTEM AND METHOD FOR DETERMINING CERENKOV BASED DEPENDENCIES

(71) Applicants: Université Laval, Québec (CA); Medscint Inc., Québec (CA)

(72) Inventors: Simon Lambert-Girard, Québec (CA); Émilie Jean, Québec (CA); François Therriault-Proulx, Québec (CA); Luc Beaulieu, Québec (CA)

(21) Appl. No.: 18/558,665

(22) PCT Filed: May 3, 2022
(86) PCT No.: PCT/CA22/50690

§ 371 Date: Nov. 2, 2023

Related U.S. Application Data
(60) Provisional application No. 63/183,340, filed on May 3, 2021.

(51) Int. Cl. G01T 1/16; G01T 1/20; G01T 1/22; G01T 7/00

(52) U.S. Cl. CPC G01T 1/1603; G01T 1/2002; G01T 1/22; G01T 7/005

(57) ABSTRACT

According to some aspects, a detector includes a sensing volume of Cerenkov generating material that is configured to sense charged particles with different angles and energies in response to irradiation and to emit a spectral and angular distribution of Cerenkov optical light indicative of an angular and energy distribution of incoming charged particles sensed by the volume of Cerenkov generating material.

### RELATED APPLICATIONS

This application is a 371 of international Application No. PCT/CA2022/050690, filed on May 3, 2022, which claims the benefit of U.S. Provisional Patent Application Ser. No. 63/183,340, filed on May 3, 2021, entitled, “DETECTOR SYSTEM AND METHOD FOR DETERMINING CERENKOV BASED DEPENDENCIES”, the entire content of which are hereby incorporated by reference herein for all purposes.

### FIELD OF THE DISCLOSURE

The present disclosure relates to a detector system and method for determining Cerenkov based dependencies such as ionizing radiation energy distribution, or radiation dose or in particular ionizing radiation distribution angle based on a measured Cerenkov optical signal.

### BACKGROUND OF THE DISCLOSURE

Cerenkov light is an emission of optical photons due to high energy charged particles traveling in a medium at speeds greater than the local speed of light. The threshold energy of the charged particle normally necessary to generate Cerenkov light emission varies according to the refractive index of the material.

Radio-luminescent elements, such as scintillation detectors, have been used for dose measurement in radiation therapy due to their advantageous characteristics over other types of radiation detectors. For example, the radio-luminescent elements can emit light proportionally to the radiation dose striking it. The radio-luminescent elements is thus of interest for quality assurance of a radiation beam prior to treatment delivery.

### SUMMARY OF THE DISCLOSURE

According to one aspect, there is disclosed a detector including a sensing volume of Cerenkov generating material, configured to sense charged particles with different angles and energies in response to irradiation and to emit a spectral and angular distribution of Cerenkov optical light indicative of an angular and energy distribution of incoming charged particles sensed by the volume of Cerenkov generating material.

For example, the detector includes a probe, wherein the sensing volume of Cerenkov generating material is positioned inside the probe.

According to one aspect, there is disclosed a detector including at least one sensing volume of Cerenkov generating material, configured to sense charged particles with different angles and energies in response to irradiation and to emit a spectral and angular distribution of Cerenkov optical light in one or more regions of an optical spectrum, the Cerenkov optical light being indicative of angular and energy distribution of charged particles sensed by the volume of Cerenkov generating material; and at least one optical guide optically coupled to the at least one sensing volume of Cerenkov generating material and configured to provide an output signal indicative of the Cerenkov optical light.

For example, the detector further includes an isolating element configured to isolate the Cerenkov optical light of the at least one sensing volume of Cerenkov generating material from any other contaminating optical signal.

For example, the isolating element can include an optical filter, a hollow-core light guide or a Cerenkov generating material with a specific transmission spectrum.

For example, the isolating element can include minimal reflection for preventing optical energy to reflect towards an emission source.

For example, the isolating element can have minimal angle sensitivity, so that light can be incident upon the filter from a wide range of angles and the filter will maintain its transmission, absorption and reflection spectral and intensity properties.

For example, the detector further includes one or more radio-luminescent elements configured to generate radio-luminescent optical signal in one or more regions of an optical spectrum.

For example, the at least one optical guide is configured to receive the radio-luminescent optical signal from the one or more radio-luminescent elements.

For example, the at least one optical guide is selected such that the radio-luminescent optical signal from the one or more radio-luminescent elements has optical spectra significantly different from the optical spectrum of the Cerenkov optical light from the at least one sensing volume of Cerenkov generating material.

For example, the at least one optical guide is configured to minimize emission of a contamination signal.

For example, the detector further includes a photodetection module optically coupled to the at least one light guide and configured to measure intensity of the Cerenkov optical light as a function of different spectral ranges.

For example, the photodetection module is further configured to measure an intensity of the radio-luminescent optical signal as a function of different spectral ranges.

For example, the detector further includes a spectral module optically coupled to the at least one optical guide and configured to receive and spectrally decouple different regions of the Cerenkov optical light.

For example, the spectral module is configured to receive and spectrally decouple different regions of the radio-luminescent optical signal.

For example, the at least one sensing volume of Cerenkov generating material and the one or more radio-luminescent elements are contiguous and/or concentric.

For example, the at least one sensing volume of Cerenkov generating material and the one or more radio-luminescent elements are arranged in a linear configuration, a two-dimensional planar configuration or a three-dimensional configuration.

For example, the volume of Cerenkov generating material include any one of: poly-methyl-methacrylate (PMMA); polystyrene (PS); polyvinyl toluene (PVT) and silica.

For example, the one or more radio-luminescent elements include a scintillator, scintillating fibers, or a fluorescent material.

For example, the detector further includes a probe wherein the at least one sensing volume of Cerenkov generating material and/or the one or more radio-luminescent elements are positioned within the probe.

For example, the at least one light guide is a single optical guide having no significant contamination signal.

For example, the detector further includes a computing device, optionally coupled to the photodetection module and/or the spectral module, and configured to receive and process electrical signals from the photodetection module and/or the spectral module to compute a measured radiation dose and an irradiation angle based on the measured intensity of Cerenkov optical light and/or the measured radio-luminescent signal.

According to one aspect, there is disclosed a method for determining a metric correlated to one or more Cerenkov signal dependencies from a given Cerenkov-generating material, including:
sensing charged particles with different angles and energies using a Cerenkov-generating material;
emitting Cerenkov optical light within the Cerenkov-generating material indicative of angular distribution of the charged particles, energy distribution of the charged particles, and deposited radiation dose;
measuring the intensity of a composed optical signal, comprised of Cerenkov optical light from the Cerenkov generating material and other contaminating signals, as a function of one or more regions of the optical spectrum;
isolating the Cerenkov optical light from any other contaminating signal;
determining a contribution of the Cerenkov optical light emitted by the Cerenkov-generating material to the composed optical signal; and
determining a metric based on the contribution and correlated to the angular distribution of charged particles, energy distribution of charged particles or radiation dose.

For example, the one or more Cerenkov signal dependencies includes any one of: an angular distribution of charged particles, an energy distribution of charged particles, and radiation dose.

For example, the method further includes sensing at least one radio-luminescent optical signal with at least one radio-luminescent element proximate to the Cerenkov-generating material.

For example, the method further includes modulating the Cerenkov optical light and/or the radio-luminescent optical signal from the at least one radio-luminescent element such that the radio-luminescent optical signal has optical spectra different from the optical spectrum of the Cerenkov optical light.

For example, the isolation step comprises modulating the Cerenkov optical light coming from the Cerenkov-generating material such that it has an optical spectrum different from any other optical signal that are part of the composed optical signal.

For example, the method further includes minimizing contamination of the Cerenkov optical light coming from the Cerenkov-generating material and/or the radio-luminescent optical signal.

For example, the volume of Cerenkov generating material includes: poly-methyl-methacrylate (PMMA); polystyrene (PS); polyvinyl toluene (PVT); or silica.

For example, the radio-luminescent element includes a scintillator, a scintillating fiber, a fluorescent material, or a phosphorescent material.

For example, the method further includes removing or accounting for a first dependency of the contribution of the Cerenkov optical light emitted by the Cerenkov-generating material to the composed optical signal.

For example, the first dependency includes any one of: a radiation dose; a charged-particles distribution angle; and a Cerenkov-generating charged particle energy spectrum.

For example, the method further includes obtaining the first dependency with any one of: a scintillation detector; a treatment planning system; Monte Carlo simulations; a dose detector; a plastic scintillation detector; a diode; an ionizing chamber; and a diamond detector.

For example, the method further includes obtaining the first dependency based on the at least one radio-luminescent element proximate to the Cerenkov-generating material.

For example, the method further includes keeping a distribution of the first dependency similar between measurement and calibration conditions.

For example, the method further includes removing or accounting for a second dependency of the contribution of the Cerenkov optical light emitted by the Cerenkov-generating material to the composed optical signal.

For example, the second dependency includes any one of: a radiation dose; a charged-particles distribution angle; and a Cerenkov-generating charged particle energy spectrum.

For example, the method further includes obtaining the second dependency with any one of: a scintillation detector; a treatment planning system; Monte Carlo simulations; a dose detector; a plastic scintillation detector; a diode; an ionizing chamber; and a diamond detector.

For example, the method further includes obtaining the second dependency based on the at least one radio-luminescent element proximate to the Cerenkov-generating material.

For example, the method further includes keeping distribution of the second dependency similar between measurement and calibration conditions.

For example, the method further includes correlating the resulting Cerenkov optical light from the Cerenkov generating material to the change in the irradiation conditions to which the sensing volume of Cerenkov generating material is subjected to.

For example, the method further includes correlating the resulting Cerenkov optical light with a gantry angle, tracking a radiation source position, or evaluating magnetic field impact on electron trajectory.

According to one aspect, there is disclosed a method for determining metrics correlated to one or more Cerenkov signal dependencies from multiple Cerenkov-generating materials, including:
sensing charged particles with different angles and energies using multiple Cerenkov-generating materials;
emitting Cerenkov optical light within the multiple Cerenkov-generating materials indicative of angular distribution of the charged particles, energy distribution of the charged particles, and deposited radiation dose at each of the multiple Cerenkov-generating materials;
measuring the intensity of at least one composed optical signal, comprised of Cerenkov optical light from at least one Cerenkov generating material and other contaminating signals, as a function of one or more regions of the optical spectrum;
isolating the Cerenkov optical light from any other contaminating signal;
determining a contribution of the Cerenkov optical light emitted by the at least one Cerenkov-generating material to the associated composed optical signal; and
determining a metric based on the contribution correlated to the angular distribution of charged particles, energy distribution of charged particles or radiation dose for each of the Cerenkov-generating materials.

### BRIEF DESCRIPTION OF THE DRAWINGS

FIG. 1 shows a radiation system for measuring an irradiation angle using Cerenkov optical signal according to one example.

FIG. 2 shows a representation of the emission spectrum of a Cerenkov detector comprising two different light emitting components along with their respective deconvolved spectra according to one example.

FIGS. 3A-3B illustrate the measuring of Cerenkov optical signal and scintillation signal at different irradiation angles using one example of embodiment of a hybrid Cerenkov-scintillation radiation detector.

FIG. 4 shows a Cerenkov calibration curve of an exemplary hybrid Cerenkov-scintillation radiation detector according to one example.

FIGS. 5A-5F show schematic side views of various embodiments of a hybrid Cerenkov-scintillation radiation detector.

FIGS. 5G and 5I show schematic side views of various embodiments of a hybrid Cerenkov-scintillation radiation detector.

FIGS. 5H and 5J show respective schematic front views of FIG. 5G,5I embodiments.

FIG. 6 shows a design schematic of two hybrid detectors according to one example.

FIG. 7 illustrates a schematic showing three different configurations used for calibration measurements according to one example.

FIG. 8 shows (left) top view of the set-up used for the validation of the Cerenkov prototype; and (right) schematic of the phantom showing the orientation of the probes.

FIG. 9 shows schematic top and side views of the set-up used for irradiation angle measurements using photon and electron beams showing the coordinate system.

FIG. 10 shows: (a) normalized spectra of each light emitting component of the Cerenkov probe used to perform the signal unmixing; and (b) total intensity measured for a 100 cGy irradiation and individual spectra of each light emitting element of the Cerenkov detector.

FIG. 11 shows ratios of a signal emitted by the Cerenkov detector sensitive volume to the deposited dose as a function of the irradiation angle obtained with (a) 6 and 18 MV photon and (b) 6, 9, 12, 16 and 20 MeV electron beams.

FIG. 12 shows: signal emitted by a Cerenkov detector sensitive volume and the BCF-12 scintillator as a function of the angle of incidence for fixed dose using (a) 6 and 18 MV photon, (b) 6 and 9 MeV and (c) 12, 16 and 20 MeV electron beams.

FIG. 13 shows: interpolated dose measured with the scintillation probe previously dose calibrated and the signal measured by the Cerenkov probe as a function of the Gantry angle using (a) 6 MV photon and (b) 20 MeV electron beams.

FIG. 14 shows Cerenkov intensity measured as a function of the Gantry angle with and without normalization to the dose measured by the scintillator at 6 MV.

FIG. 15 shows: angle of incidence absolute error measured with the Cerenkov detector using a dose varying as a function of the irradiation angle for a) 6 MV and b) 18 MV photon beams and (c) 9 MeV, (d) 12 MeV, (e) 16 MeV and (f) 20 MeV electron beams.

FIG. 16 shows ratios of the Cerenkov sensitive volume signal measured at parallel and normal incidence to the peak intensity as a function of the energy using the two detectors with numerical aperture of 0.3 and 0.5.

FIG. 17 shows an angle of incidence absolute error measured with the Cerenkov detector (NA=0.3) using a dose varying as a function of the irradiation angle for 6 MeV.

FIG. 18.a shows results obtained for the signal characterization of the Cerenkov probe under 6 and 18 MV photon beams at normal incidence for various doses. FIG. 18.b shows results for the same measurements using 6 to 20 MeV electron beams.

FIG. 19 shows a dose ratio of the Cerenkov detector to the ionization chamber as a function of the mean dose rate.

FIG. 20 shows the signal intensity of the Cerenkov probe as a function of the dose measured with the scintillation probe at various angles.

FIG. 21 shows angular calibration curves of a 6 MeV beam with Cerenkov probes.

### DETAILED DESCRIPTION OF THE DISCLOSURE

Cerenkov light is an emission of optical photons due to high energy charged particles traveling in a medium at speeds greater than the local speed of light. The threshold energy of the charged particle normally necessary to generate Cerenkov light emission will vary according to the refractive index of the material.

In the context of radiotherapy, the ionizing radiation used to treat cancerous tumors provides direct or indirect electrons with sufficient energy to generate Cerenkov light emission in many translucent media exposed to radiation, including optical fiber used in the conception of scintillating fiber dosimeter.

The number of Cerenkov optical photons emitted is directly dependent of the velocity of the charged particles traveling through the medium and hence their energy. Thus, there is a proportionality between the intensity of the emitted light and the dose deposited in the irradiated portion of the optical fiber. To link the Cerenkov optical signal to the deposited dose, it is typically necessary to determine the intensity of the signal produced in a finite sensitive volume.

Despite this proportionality, the Cerenkov light intensity collected also possesses an angular dependency. This results from the photons that are emitted in the shape of a cone with the path of the charged particle as its axis. Consequently, Cerenkov light has long been considered a contamination signal in plastic scintillating fiber dosimeters and many techniques have been developed to overcome its influence in the output signal. However, it is of interest to take advantage of this angular dependency for angle of incidence measurements.

The Cerenkov yield, that is the number of optical photons in a wavelength interval emitted per unit path length of a charged particles having an energy greater than the threshold energy of Cerenkov production, varies according to the charged particle energy spectrum. This dependency should be accounted for in order to extract angular dependency information. It could also be of interest to take advantage of the dependency for charged particle energy measurements.

According to the present disclosure, there is described detectors (for e.g., dosimeters, hybrid Cerenkov-scintillation dosimeters, etc.). The detector can include a sensing volume of Cerenkov generating material, configured to sense charged particles with different angles and energies in response to irradiation and to emit a spectral and angular distribution of Cerenkov optical light indicative of an angular and energy distribution of incoming charged particles sensed by the volume of Cerenkov generating material. The detector can include a probe, wherein the sensing volume of Cerenkov generating material is positioned inside the probe.

There is also disclosed a detector having one or more sensing volumes of Cerenkov generating material, configured to sense charged particles with different angles and energies in response to irradiation and to emit a spectral and angular distribution of Cerenkov optical light in one or more regions of an optical spectrum. The Cerenkov optical light can be indicative of angular and energy distribution of charged particles sensed by the volume of Cerenkov generating material. The detector can also include at least one optical guide optically coupled to the one or more sensing volumes of Cerenkov generating material and configured to provide an output signal indicative of the Cerenkov optical light.

The detector can also include an isolating element that isolates the Cerenkov optical light of the sensing volume of Cerenkov generating material from any other contaminating optical signal. The isolating element can be an optical filter, a hollow-core light guide or a Cerenkov generating material with a specific transmission spectrum. The isolating element can include minimal reflection for preventing optical energy to reflect towards an emission source. The isolating element can have minimal angle sensitivity, so that light can be incident upon the filter from a wide range of angles and the filter will maintain its transmission, absorption and reflection spectral and intensity properties.

The detector can also include one or more radio-luminescent elements configured to generate radio-luminescent optical signal in one or more regions of an optical spectrum. One or more optical guides can be configured to receive the radio-luminescent optical signal from the radio-luminescent elements. The optical guides can be selected such that the radio-luminescent optical signal from the radio-luminescent elements has optical spectra significantly different from the optical spectrum of the Cerenkov optical light from the sensing volume of Cerenkov generating material. The optical guides can be configured to minimize emission of a contamination signal. For example, a single optical guide having no significant contamination signal can be used.

The detector can also include a photodetection module, optionally and optically coupled to light guide(s) and configured to measure an intensity of the Cerenkov optical light as a function of different spectral ranges. The photodetection module can also be configured to measure an intensity of the radio-luminescent optical signal as a function of different spectral ranges.

The detector can further include a spectral module (or a spectral analysis module), optionally and optically coupled to the at least one optical guide and configured to receive and spectrally decouple different regions of the Cerenkov optical light. The spectral module can also be configured to receive and spectrally decouple different regions of the radio-luminescent optical signal.

The detector further can include a probe. The sensing volume of Cerenkov generating material and/or the radio-luminescent elements can be positioned within the probe.

The volume of Cerenkov generating material can include for example any one of: poly-methyl-methacrylate (PMMA); polyvinyl toluene (PVT); polystyrene (PS); and silica. The radio-luminescent elements can include a scintillation element such as a scintillator, scintillating fibers, or a fluorescent material.

The sensing volumes of Cerenkov generating material and the radio-luminescent elements can be contiguous and/or concentric. The sensing volumes of Cerenkov generating material and the radio-luminescent elements can be arranged in a linear configuration, a two-dimensional planar configuration or a three-dimensional configuration.

For example, the detector further includes a computing device, optionally coupled to the photodetection module and/or the spectral module, and configured to receive and process electrical signals from the photodetection module and/or the spectral module to compute a measured radiation dose and an irradiation angle based on the measured intensity of Cerenkov optical light and/or the measured radio-luminescent signal.

For example, a Cerenkov sensitive volume and a scintillation detector can be coupled to one or more light collecting guides whose outputs go through an optical spectral separation arrangement before being measured by a light measuring device (for e.g., a photo-detector) and the final electric signal is transferred to a computing device.

The radiation dose that is delivered to the Cerenkov sensitive volume can be calculated with the output of the scintillating element, that is proportional to the delivered dose. The irradiation angle can be calculated with the output of the Cerenkov sensitive volume, that is proportional to dose and angular dependent.

To separately measure a radiation dose, other types of dosimeters may be used such as an ionization chamber, silicon diode, diamond detector, or any other dose measuring device. The expected dose can also be calculated through simulation.

The detector can include a filter coupled to the volume of Cerenkov generating material and configured to generate a Cerenkov signal in response to the irradiation. The filter can be non-reflective for preventing optical energy towards the emission source.

Cerenkov light can be generated in the sensitive volume and the transport fiber. The emission spectrum of both signals is identical. To be distinguishable from one another, a filter can be used to modify the Cerenkov light spectrum of the sensitive volume. Unless the Cerenkov generating material possesses a transmission spectrum that differs from the transport fiber, a filter may be used.

The detector can further include at least one light guide optically coupled to the one or more radio-luminescent elements and the filter and configured to receive the optical energy from the one or more radio-luminescent elements and the Cerenkov optical signal from the filter.

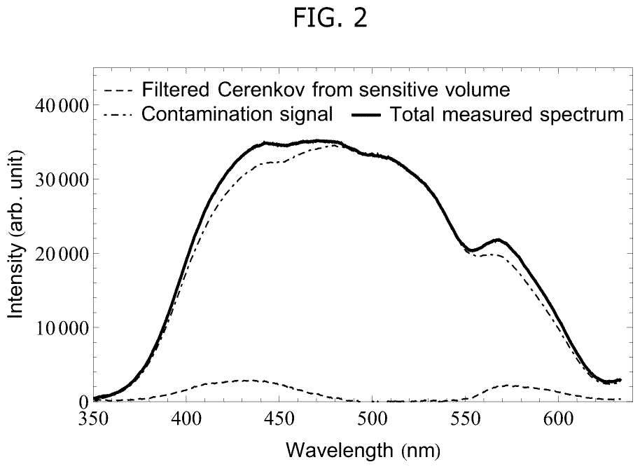

The Cerenkov spectrum can be continuous, starting from the deep UV and decreases as one on the cube of the wavelength. When measured, the spectrum shape can be affected by the absorption spectrum of the generating material and light-guide but also the photo-detector response (see FIG. 2, Contamination signal shape).

The detector can further include a light measuring device coupled to the light guide and configured to detect the optical energy from the radio-luminescent elements to measure a radiation dose and an irradiation angle signal based on the Cerenkov optical signal measured at the volume of Cerenkov generating material and the radiation dose. The light measuring device can be configured to obtain the Cerenkov optical signal differing from contamination signal produced in the at least one light guide.

The detector can further include a computing device connected to the light measuring device and configured to receive and process electrical signals from the light measuring device to compute the measured radiation dose and the irradiation angle based on the Cerenkov signal measured at the volume of Cerenkov generating material and the measured radiation dose.

The purpose of determining the Cerenkov angle can include the following. For external beam radiotherapy, the radiation angle could be used to: validate the mechanical aspect of the LINAC (numerical display is in accordance with the real gantry angle); validate VMAT, IMRT and SRS treatment plans (the dose is given at the right gantry angle); and validate in a MR-LINAC the incidence of a magnetic field on the electron trajectory and confirm the dose deposition localization. For brachytherapy, the radiation angle can be used to track the source position.

A method for determining irradiation angle is also provided in the present disclosure. The method includes: receiving Cerenkov optical signal in response to irradiation and generating a continuous Cerenkov optical signal based on the received radiation dose; generating optical energy in response to the irradiation; determining a radiation dose based on the generated optical energy; and determining the irradiation angle based on the Cerenkov optical signal and the radiation dose.

The method can be for determining the angle of ionizing particles from a radiation source (gamma rays, x-rays, electrons, etc.) using Cerenkov radiation (light emission) generated within a material exposed to the ionizing particles.

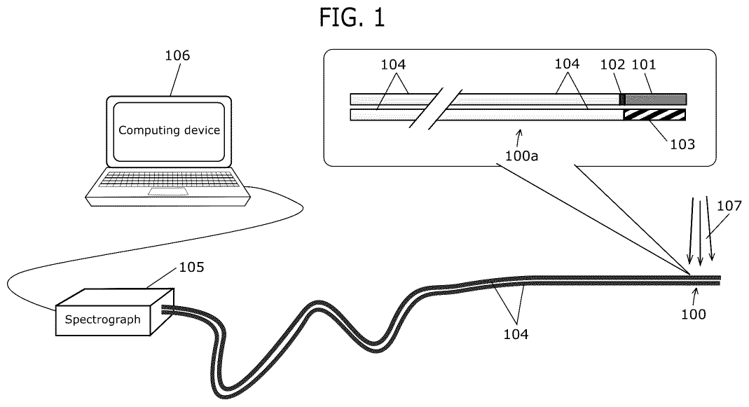

Now referring to FIG. 1 there is shown an apparatus 100 for measuring irradiation angle of a radiation source 107 based on the method described herein. The radiation source can include a medical linear accelerator (i.e. LINAC, MR-LINAC, etc.) or a brachytherapy sealed radiation source (i.e. Caesium-131, Caesium-137, Iridium-192 or other radioactive elements) and may provide X-rays, electrons, protons or any other ionizing particles.

The apparatus 100 can be used in water or human tissue-equivalent phantom of various shape and size. Such phantom can provide radiation equilibrium and may be made of a common plastic material with properties similar to water, such as polystyrene, acrylic or Lucite, or may be some other special chemical compound designed to be similar to water or human tissue. It may also be desired to use the detector in an application that has no phantom, for example, during a radiotherapy treatment with the apparatus 100 placed on a patient.

In FIG. 1, the apparatus 100a includes a Cerenkov sensitive volume 101, an absorptive filter 102, a radio-luminescent element 103 and two independent optical light guides 104.

The Cerenkov sensitive volume can include any Cerenkov generating material such as, but not limited to, Poly-methyl-methacrylate (PMMA), Polyvinyl toluene (PVT), Polystyrene (PS) or silica.

The absorptive filter can be a non-reflective filter that guarantee no energy is reflected towards its emission source, and consisting of a transmitting filter and a blocking filter, with their respective transmission and rejection ranges set to the same wavelengths.

Transmission and rejection wavelength ranges can include one or more narrow, wide or continuous bands and depend on the filter type. For example, the filter type can include longpass, shortpass, bandpass filter or any other filter that impinges the spectrum. Photodetectors that are sensitive in the UV-visible-near infrared range can be used. The filter can block a portion of the Cerenkov spectrum somewhere in the same range. The absorptive filter can include plastic thin film, colored glass, or other suitable materials.

The radio-luminescent element can include scintillators, such as organic plastic scintillators. For example, they can include anthracene-doped Poly-Vinyl-Toluene (PVT) such as BC-400, Polystyrene or Poly-methyl-methacrylate based scintillators, or scintillating fibers with a polystyrene-based core and Poly-methyl-methacrylate-based cladding such as BCF-12 from Saint-Gobain or similar from other manufacturers.

The radio-luminescent element can also include an inorganic scintillator. For example, the scintillator can be an alkali halide (i.e. CsI(Ti), NaI(Ti), etc.), cerium-activated (i.e. GSO(Ce), YAP(Ce), LSO(Ce), etc.), or another suitable scintillating material.

The optical light guide can include optical fiber with a silica or polymer-based core, and a polymer cladding and coating. In some case, the cladding and protective coating may be omitted. In other case, the optical light guide can be a hollow core optical fiber or any other suitable light transmitting guide. Noise in the optical light guide is called a stem effect and can be mainly composed of Cerenkov. Some fluorescence can also be observed. The intensity of the contamination signal can depend on the length irradiated and the incident angle.

Typical Cerenkov sensitive volume and radio-luminescent element have a cylindrical shape of 0.5 to 1 mm diameter and a length of 1 mm or more. However, in some embodiments, one or more components may have other shapes and sizes. In particular, one or more of the Cerenkov sensitive volume, absorptive filter, scintillating element and light guides may have other cross sectional shapes, such as squares, ellipses or other cross sectional shapes, and may differ from each other.

Therefore, when ionizing particles are emitted from a radiation source 107 to the Cerenkov sensitive volume 101, the Cerenkov optical signal generated in the Cerenkov sensitive volume 101 passes through the absorptive filter 102 that eliminates a spectral band from the Cerenkov spectrum. In most cases, Cerenkov optical signal is also generated in the optical light guide 104 exposed to the ionizing particles emitted from the radiation source and is referred as a contamination signal. The residual filtered Cerenkov spectrum from the sensitive volume is added to the contamination signal and is transferred to a spectrograph 105 through a light guide 104, and a final signal is transmitted to a computing device 106.

Simultaneously, when ionizing particles are emitted from a radiation source 107 to the radio-luminescent element 103, it results in the generation of scintillation light in an amount proportional to the radiation dose detected. The scintillation light is added to the contamination signal generated in the light guide 104 and is transferred to the spectrograph 105 through an independent optical light guide 104, and a final signal is transmitted to the computing device 106.

The spectrograph 105 is used to spatially and spectrally disperse the optical energy from the collecting light guide 104 into its many wavelength components. The spectrally dispersed light is then collected by a photo-detector array that output an indication of the intensity for each wavelength component. Suitable devices and techniques for spatially and spectrally disperse the optical energy and converting a light signal to an electronic signal and outputting an indication of the intensity of the light signal are well known and will therefore not be described herein.

The computing device 106 can include a desktop computer, laptop, custom circuitry or dedicated hardware that receives the electrical signals from the spectrograph 105, processes the signals and can perform any suitable calculations.

The total measured spectrum obtained through a single optical light-guide 104 may be characterized as a linear combination of the different light emitting sources regardless of whether the light comes from Cerenkov sensitive volume, radio-luminescent elements or radiation-induced contaminating signal from an optical light-guide. Signal contribution of each element to the total measured spectrum is obtained by performing a spectral unmixing. Details of the spectral unmixing method performed using a hyper spectral approach can be found in “A mathematical formalism for hyperspectral, multipoint plastic scintillation detectors”, Archambault L, Therriault-Proulx F, Beddar S and Beaulieu L, Phys. Med. Biol. Vol. 57, pp. 7133-45, (2012).

Now referring to FIG. 2, shown therein is an example representation of a measured spectrum through a single optical light-guide and the contribution of each component obtained by a spectral unmixing process. The total measured spectrum is composed of two different light emitting components, comprising a Cerenkov sensitive volume delimited by an absorptive filter and a contaminating component from an optical light guide.

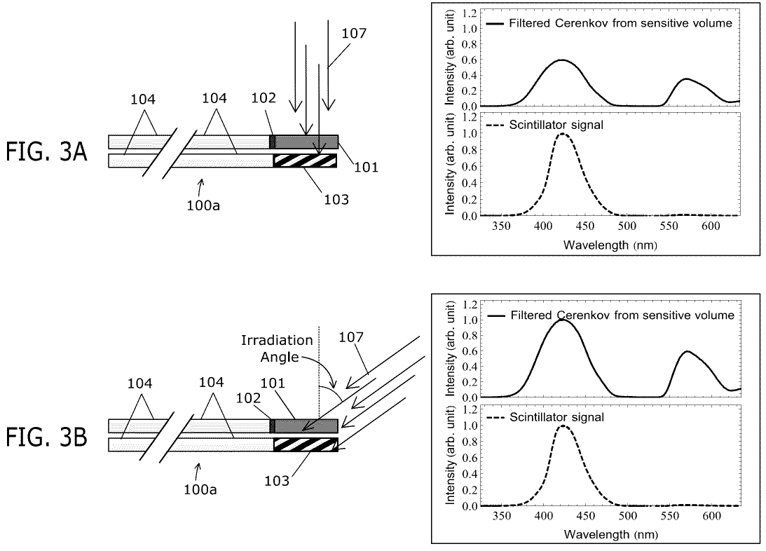

Referring to FIG. 3A there is shown an apparatus 100a including a Cerenkov sensitive volume 101 and a radio-luminescent element 103, and their respective measured spectra for a given deposited dose when irradiated by a radiation source 107. Presented spectra do not include the transport fiber contamination signal that is eliminated by performing a spectral unmixing. In this example, the irradiation angle is at normal incidence with respect to the Cerenkov sensitive volume 101 and the radio-luminescent element 103. FIG. 2B shows the apparatus 100a of FIG. 3A and the respective measured spectra for the same given deposited dose when irradiated by a radiation source 107 at an angle that is not at normal incidence with respect to the Cerenkov sensitive volume 101 and the radio-luminescent element 103.

The irradiation angle is defined herein as the angle formed by the ionizing particle track and a line perpendicular to the cylindrical Cerenkov sensitive volume 101 central axis. For example, the described coordinate system can be arbitrary and the irradiation angle can be defined with respect to any line passing through the point of incidence of the particle track.

The variation of the intensity of the Cerenkov sensitive volume 101 signal between FIG. 3A and FIG. 3B results from the angular dependency of the Cerenkov optical signal. The angular dependency of the Cerenkov sensitive volume 101 is defined as the variation of the measured signal as a function of the irradiation angle, for an equal dose delivered by the radiation source 107, that depends only of the charged particle track angle.

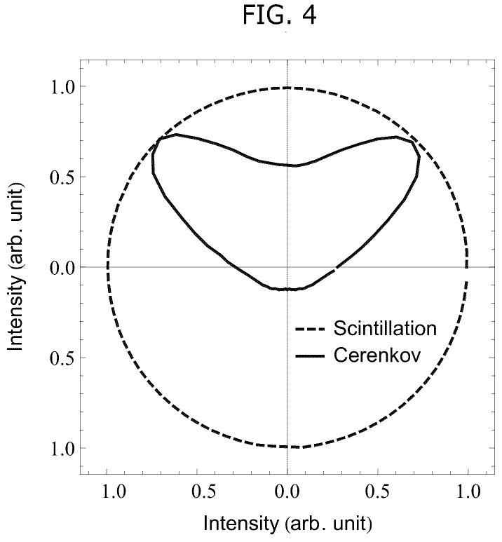

Referring now to FIG. 4, shown therein is an example representation of a polar plot calibration curve of the Cerenkov angular dependency measured with the apparatus 100a in terms of arbitrary intensity units per dose units as a function irradiation angle. For the generation of the calibration curve, the Cerenkov sensitive volume 101 and the radio-luminescent element 103 are embedded in a cylindrical water-equivalent phantom to maintain the depth of measurement and the distance between the radiation source 107 and the hybrid Cerenkov-scintillation detector 100 equal regardless of the irradiation angle. The signal intensity of the Cerenkov sensitive volume 101 and the radio-luminescent element 103 is recorded for an equal delivered dose at each irradiation angle, and an angular calibration function is obtained using the calibration curve of the Cerenkov sensitive volume. This angular calibration function can be used to determine the irradiation angle in any irradiation condition. The calibration equation is a polynomial fit obtained using an interpolation of the calibration curve. As the calibration curve will vary depending on energy, depth of measurements, sensitive volume material, transport fiber type, etc., the equation will also vary.

According to a first method described in the present disclosure, the determination of the irradiation angle can be done in a four steps process:
Step 1: measuring, with a finite sensitive volume of Cerenkov generating material delimited by an absorptive filter, the Cerenkov optical signal intensity induced by a radiation source;
Step 2: measuring the radiation dose that is delivered to the Cerenkov sensitive volume with, for example, the output of the radio-luminescent element, that is proportional to the delivered dose regardless of the irradiation angle. The radiation dose can be also separately measured with other types of dosimeters such as an ionization chamber, silicon diode, diamond detector, or any other dose measuring device. The expected dose can also be calculated through simulation.
Step 3: eliminating the dose dependency of the measured Cerenkov optical signal by dividing the measured Cerenkov sensitive volume intensity by the measured dose to obtain an intensity value in terms of intensity units per dose units;
Step 4: identifying the irradiation angle by solving the angular calibration function for the Cerenkov sensitive volume intensity normalized to the delivered dose.

According to one embodiment, a method for determining a metric correlated to one or more Cerenkov signal dependencies from a given Cerenkov-generating material includes: sensing charged particles with different angles and energies using a Cerenkov-generating material; emitting Cerenkov optical light within the Cerenkov-generating material indicative of angular distribution of the charged particles, energy distribution of the charged particles, and deposited radiation dose; measuring the intensity of a composed optical signal, comprised of Cerenkov optical light from the Cerenkov generating material and other contaminating signals, as a function of one or more regions of the optical spectrum; isolating the Cerenkov optical light from any other contaminating signal; determining a contribution of the Cerenkov optical light emitted by the Cerenkov-generating material to the composed optical signal; and determining a metric based on the contribution and correlated to the angular distribution of charged particles, energy distribution of charged particles or radiation dose.

The one or more Cerenkov signal dependencies can include any one of: an angular distribution of charged particles, an energy distribution of charged particles, and radiation dose.

The method can further include sensing at least one radio-luminescent optical signal with at least one radio-luminescent element proximate to the Cerenkov-generating material.

The method can further include modulating the Cerenkov optical light and/or the radio-luminescent optical signal from the at least one radio-luminescent element such that the radio-luminescent optical signal has optical spectra different from the optical spectrum of the Cerenkov optical light.

The isolation step can include modulating the Cerenkov optical light coming from the Cerenkov-generating material such that it has an optical spectrum different from any other optical signal that are part of the composed optical signal.

The method can further include minimizing contamination of the Cerenkov optical light coming from the Cerenkov-generating material and/or the radio-luminescent optical signal. For example, the volume of Cerenkov generating material includes: poly-methyl-methacrylate (PMMA); polystyrene (PS); polyvinyl toluene (PVT); or silica. For example, the radio-luminescent element includes a scintillator, a scintillating fiber, a fluorescent material, or a phosphorescent material.

The method can further include removing or accounting for a first dependency of the contribution of the Cerenkov optical light emitted by the Cerenkov-generating material to the composed optical signal. For example, the first dependency includes any one of: a radiation dose; a charged-particles distribution angle; and a Cerenkov-generating charged particle energy spectrum.

The method can further include obtaining the first dependency with any one of: a scintillation detector; a treatment planning system; Monte Carlo simulations; a dose detector; a plastic scintillation detector; a diode; an ionizing chamber; and a diamond detector.

The method can further include obtaining the first dependency based on the at least one radio-luminescent element proximate to the Cerenkov-generating material.

The method can further include keeping a distribution of the first dependency similar between measurement and calibration conditions.

The method can further include removing or accounting for a second dependency of the contribution of the Cerenkov optical light emitted by the Cerenkov-generating material to the composed optical signal. For example, the second dependency includes any one of: a radiation dose; a charged-particles distribution angle; and a Cerenkov-generating charged particle energy spectrum. The method can further include obtaining the second dependency with any one of: a scintillation detector; a treatment planning system; Monte Carlo simulations; a dose detector; a plastic scintillation detector; a diode; an ionizing chamber; and a diamond detector. For example, the method further includes obtaining the second dependency based on the at least one radio-luminescent element proximate to the Cerenkov-generating material.

The method can further include keeping distribution of the second dependency similar between measurement and calibration conditions.

The method can further include correlating the resulting Cerenkov optical light from the Cerenkov generating material to the change in the irradiation conditions to which the sensing volume of Cerenkov generating material is subjected to.

For example, the method further includes correlating the resulting Cerenkov optical light with a gantry angle, tracking a radiation source position, or evaluating magnetic field impact on electron trajectory.

According to another embodiment, a method for determining metrics correlated to one or more Cerenkov signal dependencies from multiple Cerenkov-generating materials includes: sensing charged particles with different angles and energies using multiple Cerenkov-generating materials; emitting Cerenkov optical light within the multiple Cerenkov-generating materials indicative of angular distribution of the charged particles, energy distribution of the charged particles, and deposited radiation dose at each of the multiple Cerenkov-generating materials; measuring the intensity of at least one composed optical signal, comprised of Cerenkov optical light from at least one Cerenkov generating material and other contaminating signals, as a function of one or more regions of the optical spectrum; isolating the Cerenkov optical light from any other contaminating signal; determining a contribution of the Cerenkov optical light emitted by the at least one Cerenkov-generating material to the associated composed optical signal; and determining a metric based on the contribution correlated to the angular distribution of charged particles, energy distribution of charged particles or radiation dose for each of the Cerenkov-generating materials.

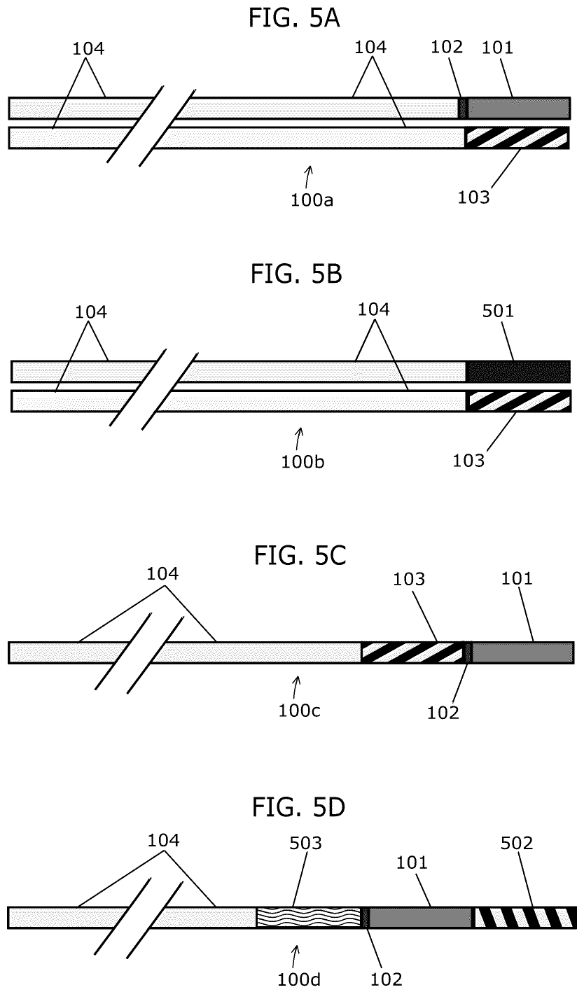

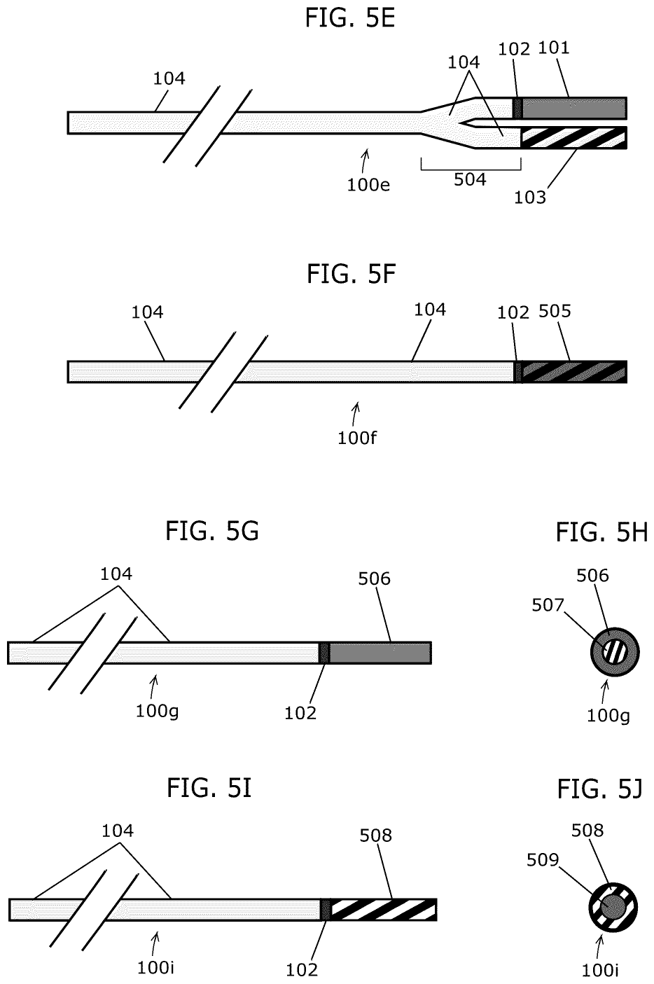

Referring to FIG. 5A there is shown an apparatus 100a including a Cerenkov sensitive volume 101, an absorptive filter 102, a radio-luminescent element 103 and two independent optical light guides 104.

Referring to FIG. 5B there is shown an apparatus 100b including a filtering Cerenkov sensitive volume 501, a radio-luminescent element 103 and two independent optical light guides 104 for measuring irradiation angle. In this embodiment, the Cerenkov sensitive volume 501 can include any absorptive filtering material that is also Cerenkov generating.

Referring to FIG. 5C there is shown an apparatus 100c including a Cerenkov sensitive volume 101, an absorptive filter 102, a radio-luminescent element 103 and a single optical light guide 104 that are connected to one another.

Referring to FIG. 5D there is shown an apparatus 100d including a Cerenkov sensitive volume 101, an absorptive filter 102, two different radio-luminescent elements 502 and 503 with different emission spectra, and a single optical light guide 104 that are connected to one another.

Referring to FIG. 5E there is shown an apparatus 100e including a Cerenkov sensitive volume 101, an absorptive filter 102, a radio-luminescent element 103 connected to a single optical light guide 104 with an optical splitter 504.

Referring to FIG. 5F there is shown an apparatus 100f including a radio-luminescent element 505, an absorptive filter 102 and a single optical light guide 104. In this embodiment, the Cerenkov sensitive volume and the radio-luminescent are combined together, and the radio-luminescent element includes a Cerenkov generating material.

Referring to FIG. 5G there is shown an apparatus 100g including a hollow core Cerenkov sensitive volume 506, an absorptive filter 102, a radio-luminescent element 103 (not shown in FIG. 5G) and a single optical light guide 104. FIG. 5H shows a front view of the apparatus 100g of FIG. 5G where the radio-luminescent element 507 is embedded in the hollow core Cerenkov sensitive volume 506.

Referring to FIG. 5I there is shown an apparatus 100i including a hollow core radio-luminescent element 507, an absorptive filter 102, a Cerenkov sensitive volume 508 (not shown in FIG. 5I) and a single optical light guide 104. FIG. 5J shows a front view of the apparatus 100i of FIG. 5I where the Cerenkov sensitive volume 508 is embedded in the hollow core radio-luminescent element 507.

The various embodiments of detectors described herein may provide several advantages over existing techniques. In one application, one or more of the teachings herein may be used for in vivo dosimetry, wherein at least a portion of the detector is placed on or inserted into a patient, and the patient is then irradiated.

### Experiment #1: Characterization of a Novel Detector

This experiment presents the characterization of a novel detector intended to be used to extract dose as well as the irradiation angle based on Cerenkov optical signal angular dependency.

A fiber-based Cerenkov detector composed of a 10-mm long sensitive volume of clear PMMA optical fiber separated by an absorptive filter from a 1-mm diameter transport fiber was built. Both filtered and raw Cerenkov signals respectively from the sensitive volume and transport fiber were collected using the Hyperscint-RP-200 (Medscint, Quebec) scintillation dosimetry platform. The total signal was deconvolved using a hyperspectral approach to eliminate the transport fiber signal contribution. Dose calibration of the detector signal was accomplished with repeated irradiations of 200 cGy using photon (6-18 MV) and electron (6-20 MeV) beams. Using a solid-water phantom, measurements at fixed incident angles covering a wide range of doses and output factors were realized.

For fixed incident angle, signal characterization of the Cerenkov detector displays a linear dose-light relationship for the whole range of doses tested with various photon and electron beam energies. The sensitive volume signal was found to be energy dependent. Output factors were accurately measured within +0.8% for field size up to 25×25 cm² with both photons and electrons. Therefore, the ability to accurately measure clinical photon and electron beams deposited dose using a Cerenkov detector was shown. Also shown were ability to measure Cerenkov irradiation angle according to the present disclosure.

### Experiment #2: External Beam Irradiation Angle Measurement Using Cerenkov Emission

Due to its angular dependency, Cerenkov light has long been considered a contamination signal in plastic scintillating dosimeters. In this study, a novel approach is proposed and designed to take advantage of this angular dependency to perform a direct measurement of an external beam radiation angle of incidence. A Cerenkov probe composed of a 10-mm long filtered sensitive volume of clear PMMA optical fibre was built. Both filtered and raw Cerenkov signals from the transport fibre were collected through a single 1-mm diameter transport fibre. An independent plastic scintillation detector composed of 10-mm BCF12 scintillating fibre was also used for simultaneous dose measurements. A first series of measurements aimed at validating the ability to account for the Cerenkov electron energy spectrum dependency by simultaneously measuring the deposited dose, thus isolating signal variations resulting from the angular dependency. A cylindrical phantom was then used to obtain an angular calibration curve for fixed dose irradiations and perform incident angle measurements using electron and photon beams. The beam nominal energy was found to have a significant impact on the shapes of the angular calibration curves obtained for irradiation angle measurements. This can be linked to the electron energy spectrum dependency of the Cerenkov emission cone. Irradiation angle measurements exhibit an absolute mean error of 1.86° and 1.02° at 6 and 18 MV, respectively. Similar results were obtained with electron beams and the absolute mean error reaches 1.97°, 1.66°, 1.45° and 0.95° at 9, 12, 16 and 20 MeV, respectively. Reducing the numerical aperture of the Cerenkov probe leads to an increased angular dependency for the lowest energy while no major changes were observed at higher energy. This allowed irradiation angle measurements at 6 MeV with a mean absolute error of 4.82°. The detector offers promising perspectives for external beam radiotherapy and brachytherapy applications.

### 1. Introduction

Improvement of radiotherapy techniques has emphasized the need to perform dosimetric quality assurance tests to ensure that radiation dose is safely and correctly delivered to the tumour (Solberg et al 2012). Techniques such as stereotactic radiotherapy (SBRT) and intensity modulated radiotherapy (IMRT) employ a larger number of small fields and modulated beams (Meyer 2011, Elith et al 2011) while development of magnetic resonance image-guided accelerator (MR-LINAC) implies the presence of a magnetic field (Liney and Heide 2019). These techniques have been developed to improve treatments by maximizing the dose to the tumour while also sparing surrounding tissues. However, they also increase the complexity of dose measurements and highlight the limitations of existing dosimeters (Ezzell et al 2003, Benedict et al 2010, Solberg et al 2012, Jelen and Begg 2019, Solberg et al 2012, O'Brien et al 2018).

Considering the dosimetry challenges of recent radiotherapy treatments, plastic scintillation detectors are considered well-suited tools due to their high spatial resolution, fast response, water-equivalence and relatively low magnetic field dependency (Beaulieu and Beddar 2016, Madden et al 2019, Alexander et al 2020, Cumalat et al 1990, Therriault-Proulx et al 2018). While they show numerous advantages, irradiation of plastic fibres with megavoltage beams also implies production of Cerenkov light (Beddar et al 1992, Boer et al 1993). This inherent light emission has long been considered a contamination signal due to its multiple dependencies leading to intensity variations that are not directly linked to the dose deposition (Law et al 2006, 2007). Consequently, many techniques have been developed over the past years to overcome its influence in the output signal (Frelin et al 2005, Archambault et al 2006, Lambert et al 2008, Liu et al 2011).

On the other hand, interest for Cerenkov emission dosimetry has increased over the past decades. While most emerging techniques are focusing on in-vivo Cerenkov imaging (Tendler et al 2020, Hachadorian et al 2020) or inwater detection with an out-of-field detector (Glaser et al 2013, 2014, Pogue et al 2015, Meng et al 2019, Zlateva et al 2019a, 2019b, Yogo et al 2020), few are based on Cerenkov light produced in optical fibres (Jang et al 2013, Yoo et al 2013). Challenges of using Cerenkov signal from an optical fibre arise from the delimitation of a sensitive volume and the signal discrimination of the Cerenkov also produced in the transport fibre itself. The number of Cerenkov photons emitted is directly dependent of the velocity of the electrons travelling through the medium, and hence their energy (Jelley, 1958). Thus, there is a proportionality between the intensity of the emitted light and the dose deposited in the irradiated portion of the optical fibre. It is however necessary to determine the intensity of the signal produced in a finite sensitive volume to link it to the deposited dose. Despite this proportionality, the Cerenkov light intensity collected also possesses an angular dependency (Law et al 2006, 2007). This results from the optical photons that are emitted in a conical shape with its axis centred along the path of the charged particle. Thus, its angular dependency could be useful to extract additional information that is out of reach when using other dosimeters and can only be obtained with Monte Carlo simulations.

In this study, a novel hybrid Cerenkov scintillation detector that exploits Cerenkov light generated in a clear PMMA optical fibre is introduced. The detector is designed to simultaneously performed dose measurements and identify the primary photon or electron beam incident angles based on Cerenkov angular dependency. Accordingly, the main objective of the present study is to investigate the angular dependency of a novel hybrid Cerenkov-scintillation detector that exploits Cerenkov light generated in a clear PMMA optical fibre. Moreover, it aims at validating the ability of the detector to perform simultaneous dose and irradiation angle measurements by using Cerenkov signal variations attributable to its angular dependency.

### 2. Materials and Methods

### 2.1 Cerenkov Radiation

Cerenkov radiation is the emission of optical photons that occurs when a charged particle travels through a dielectric medium with a velocity greater than the local velocity of light (Cherenkov 1934, Jelley 1958). The resulting optical photons are emitted in the shape of a cone with the path of the charged particle as its axis and having a half-opening angle θ. Considering an optical fibre having a PMMA-based core with refractive index of 1.49 (at 520 nm), the minimal energy required for an electron to generate Cerenkov radiation is 178 keV. Thus, external beams from medical linear accelerator (LINAC) composed of photons or electrons will induce in the exposed optical fibre and surrounding media a polyenergetic electron fluence spectrum of which most of the electrons possess an energy greater than the threshold (Mclaughlin et al 2018, Konefał et al 2015). The Cerenkov yield, that is the number of optical photons dN in the wavelength interval between 11 and 12 emitted per unit path length dl of a charged particle having an energy greater than the threshold, is given by the Frank-Tamm formula (Tamm and Frank 1937)

$$\frac{dN}{dl} = 2 π α {z}^{2} ( 1 - \frac{1}{{β}^{2} {n}^{2}} ) ( \frac{1}{{λ}_{2} - {λ}_{1}} ) , \qquad ( 1 )$$

where α is the dimensionless fine-structure constant and z the charge of the particle. According to Equation (1), the number of optical photons emitted within the fibre increases with the particle energy and the refractive index. The same also applies to the Cerenkov cone half-opening angle θ. However, influence of the refractive index variation of PMMA over the visible spectrum (i.e., 400-700 nm) is considered negligible (Zhang et al 2020). Therefore, Cerenkov light emission intensity and angle mostly depend on the energy fluence spectrum. As the dose deposited in the medium by the electrons also depends on their energy spectrum, normalizing the Cerenkov signal to the measured dose should allow to eliminate this dependency. Consequently, signal variations attributable to angular dependency could be used to extract the irradiation angle with an angular calibration curve performed under fixed dose irradiations.

### 2.2 Detector Conception

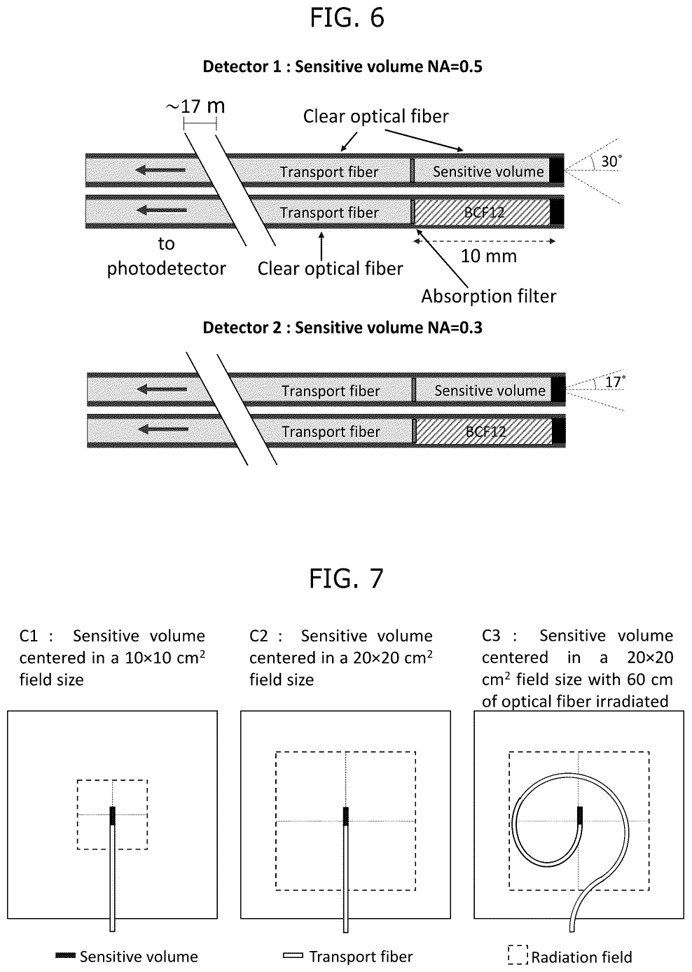

FIG. 6 shows the design schematic of two hybrid detectors showing the Cerenkov and the scintillation probe assemblies. The critical angle and acceptance cone according to the numerical aperture are also shown.

The hybrid Cerenkov-scintillation detector designed for this study was composed of two distinct probes as shown in FIG. 1. A first fibre-based Cerenkov detector was built similarly as a single-point plastic scintillation dosimeter (PSD). A 10 mm long optical fibre with a PMMA-based core and fluorinated polymer-based cladding (1 mm diameter ESKA GH-4001, Mitsubitshi Chemical Co., Tokyo, Japan) was used as a finite sensitive volume. The latter was separated by an absorptive filter from a 17 m long transport fibre (ESKA GH-4001) to modify the Cerenkov spectrum produced in the sensitive volume, thus allowing for an algorithm to properly eliminate the contamination signal from the transport fibre. An absorptive filter was preferred to guarantee no light emission was reflected towards its emission source. To increase the total signal collected, the same type of fibre was used to generate and conduct the Cerenkov light to a photodetector due to its high core-cladding refractive index difference Δn of 0.11. All components were bonded together using an optical adhesive and sealed with a 3D printed (SL1 printer, Prusa, Prague, Czech Republic) light tight tube made of photo-hardening polyresin. An independent similarly built PSD composed of a 10 mm long BCF12 scintillating fibre (Saint-Gobain, Hiram, USA) was also used simultaneously to provide a real-time dose measurement and account for the Cerenkov electron energy dependency.

A second hybrid Cerenkov-scintillation detector was also built to evaluate the influence of the acceptance cone on the Cerenkov signal collected and angular dependency. The only difference between the two detectors lies in the sensitive volume optical fibre (1 mm diameter ESKA MH4001, Mitsubitshi Chemical Co., Tokyo, Japan) having a numerical aperture of 0.3 instead of 0.5. While the latter was used thorough the entire characterization, the former only serve for comparison measurements. Subsequent references to the detector refer to the first prototype with a numerical aperture of 0.5 unless otherwise stated.

### 2.3 Signal Acquisition Set-Up

Irradiations of the detector were carried out using a Varian Clinac IX (Varian Medical Systems, Palo Alto, USA) linear accelerator. For all measurements, 6 and 18 MV photon and 6, 9, 12, 16 and 20 MeV electron beams were used. Absolute doses and dose-rates were validated using a Farmer ionization chamber (TN 31013, PTW, Freiburg, Germany). The multichannel HYPERSCINT scintillation dosimetry platform (HYPERSCINT RP-200, Medscint Inc., Quebec, Canada) was used to collect simultaneously the light signal emitted by both probes of the detector (Jean et al 2021). The transport fibres of 17 m long allowed to place the HYPERSCINT platform outside the treatment room to minimize noise. All measurements were achieved using a wavelength range set from 350 to 635 nm which represents an effective area of 2260 pixels wide on the photodetector. To reduce the readout noise, a binning was performed in the vertical direction of the sensor on 100 pixels for each channel and the cooling system was set at −5° C. to keep the temperature stable across all measurements. Each acquisition was made using a repetitive 2 s integration time. Background exposures with matching exposure time were also taken and subtracted from the acquired signal.

### 2.4 Signal Unmixing and Dose Calibration

The signal of both probes was collected and unmixed independently using the hyperspectral approach (Archambault et al, 2012). The measured spectrum (m) is assumed to be a linear superposition of the normalized spectra (rᵢ) of the different light emitting sources and pixels of the detector array are considered as L individual measurement channels to which are assigned wavelengths (λⱼ). This can be expressed in matrix form such as

$$[ \begin{matrix}{m}_{λ 1} \\ {m}_{λ 2} \\ ⋮ \\ {m}_{λ L}\end{matrix} ] = [ \begin{matrix}{r}_{1 , λ 1} & {r}_{2 , λ 1} & … & {r}_{n , λ 1} \\ {r}_{1 , λ 2} & {r}_{2 , λ 2} & … & {r}_{n , λ 2} \\ ⋮ & ⋮ & ⋮ & ⋮ \\ {r}_{1 , λ L} & {r}_{2 , λ L} & … & {r}_{n , λ L}\end{matrix} ] [ \begin{matrix}{x}_{1} \\ {x}_{2} \\ ⋮ \\ {x}_{n}\end{matrix} ] . \qquad ( 2 )$$

where xᵢ represents the contribution of each light emission sources i. As the BCF12 and the clear fibre probes are constructed as single-point PSD, only the scintillation and the filtered Cerenkov from the sensitive volume contributes to the measurement, respectively. The total measured spectrum also includes two contamination signals from the transport fibre that is exposed to the beam, which are unfiltered Cerenkov and fluorescence (Nowotny 2007, Boer et al 1993, Therriault-Proulx et al 2013). Thus, the variable n in this study is equal to 3 to account for all light emission sources.

To solve the system for the variable x, the left pseudo-inverse matrix method is used as follows

$$x = {( {R}^{T} R )}^{- 1} {R}^{T} m . \qquad ( 3 )$$

The raw spectrum of each element that contributes to the total signal measured is required to solve Equation (3). Contrary to plastic scintillator detectors, it is not possible to use a beam with lower energy than the Cerenkov threshold to obtain raw spectra of the Cerenkov probe sensitive volume. Accordingly, a procedure similar to the one described by Guillot et al. (Guillot et al 2011) was used. As illustrated in FIG. 2, the probe was irradiated in 3 respective conditions. C2 and C3 measurements are performed using an irradiation angle where the fluorescence to Cerenkov ratio is minimized (i.e., at the maximal Cerenkov emission angle) while the C1 measurement is performed at normal incidence using a known dose. The difference between calibration measurements C3 and C2 is only due to contamination signal as the dose received to the sensitive volume in both conditions is identical. Therefore, the contamination signal is then used to unmix the C1 measurement signal and hence extract the sensitive volume raw spectrum. As for the fluorescence, 60 cm of rolled transport fibre was directly placed on the exit window of the On-Board Imaging kV source arm (OBI, Varian Medical Systems, Palo Alto, USA). The latter was set at 120 kVp for a 40 second irradiation.

FIG. 7 illustrates a schematic showing the three different configurations used for the calibration measurements.

The intensity (x_{i,c1}) calculated for the deposited dose (d_{i,c1}) with irradiation C1 is then used to determine the dose received in other irradiation conditions (dᵢ) such as

$${d}_{i} = {d}_{i , C 1} \frac{{x}_{i}}{{x}_{i , C 1}} . \qquad ( 4 )$$

While the equation (4) is valid for any irradiation conditions when using a scintillation detector, nominal energy, angle and depth of measurement must match those of the calibration irradiation for a Cerenkov detector used for dosimetry purpose. Consequently, the Cerenkov detector signal was dose calibrated at a dₘₐₓ depth (i.e. 1.5 cm at 6 MV, 3.5 cm at 18 MV, 1.5 cm at 6 MeV, 2 cm at 9 MeV and 3 cm at 12, 16 and 20 MeV) and at normal incidence for this study.

### 2.5 Dose Linearity, Output Factors and Dose Rate Independence

First measurements aimed at evaluating the efficiency of the absorptive filter to produce a sufficiently distinct Cerenkov spectrum allowing for the algorithm to properly eliminate the signal from the transport fibre. Given that, the Cerenkov probe was used in the same manner as a PSD. Both probes were embedded in a solid water phantom at a dₘₐₓ depth with their sensitive volume at the isocentre, and a 10 cm thick slab was placed underneath to provide backscatter. Irradiations were performed at normal incidence with respect to the fibre axis (i.e., Gantry at 0° with the probes along the lateral axis)

Dose linearity measurements were achieved using the clear fibre probe signal as a function of the deposited dose measured by the scintillator. Irradiations consisted of various doses ranging from 20 cGy to 500 cGy in a 10×10 cm² field size. Then, output factors were measured for field sizes varying from 5×5 to 25×25 cm² using 3 repeated irradiations of 100 cGy for each energy. To calculate the relative outputs, the signal measured with both probes at field size n×n cm², using jaw-defines fields for photons and applicator size for electrons, was normalized to the signal measured under a 10×10 cm² field.

Validation of the dose rate independence was achieved using a 10×10 cm² field size with the surface-to-source distance (SSD) gradually increased to reduce the mean dose rate. For each couch position, respectively five irradiations of 200 cGy at 600 MU/min were realised under 6 and 18 MV photon beams only. To account for the field size variation, attenuation in air, and treatment room backscattering at high SDD, absolute dose rate measurements relative to SSD were performed with a TN 31013 ionization chamber, to which the Cerenkov probe measured doses were then normalized.

### 2.6 Angular Dependency

A validation of the angular dependency was obtained with irradiations ranging from 20 cGy to 500 cGy using a 10×10 cm² field size. Measurements were repeated at various Gantry angles between 0° to 90°. To ensure a constant depth of measurement regardless of the gantry angle, all measurements were carried out with the two probes inserted in solid cylindershaped water-equivalent phantom. The latter was manufactured using a 3D-printer (MK3S+ and SL1, Prusa, Prague, Czech Republic) and was composed of a methacrylate polymers resin (Polyresin-Tough, Prusa Polymers, Prague, Czech Republic). A first phantom of 6 cm diameter was used for the photon beams as well as the 12 to 20 MeV electron beams. A smaller cylinder of 3 cm diameter was used for lower electron energies to provide a depth of measurement closer to the dₘₐₓ depth. As illustrated in FIG. 3, the phantoms were suspended in the air on a stand at the foremost longitudinal position to avoid any beam attenuation from the treatment table. Both probes were placed along the lateral axis with their sensitive volumes pointing toward the X2 jaw.

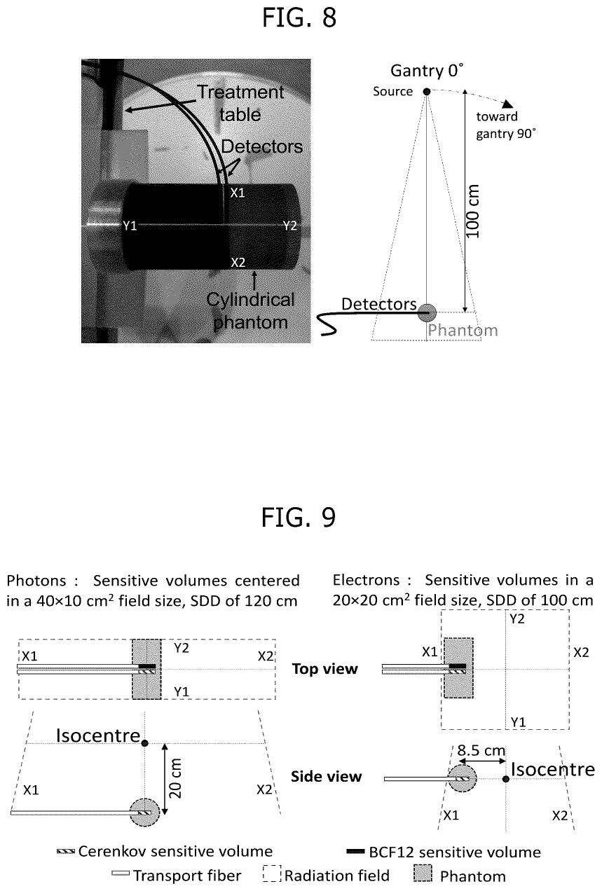

FIG. 8 shows the following: (left) top view of the set-up used for the validation of the Cerenkov prototype showing the 2 probes inserted in the 3D printed cylindrical phantom placed on its stand; and (right) schematic of the phantom showing the orientation of the probes with respect to the Gantry position.

### 2.7 Angular Calibration Curve

Calibration curves of the Cerenkov signal intensity as a function of the radiation incident angle for fixed doses of 200 cGy were performed in a 10×10 cm² field size. For the photon beams, the whole 360 degrees was covered using increments of 5 degrees. For the electron beams, the applicator hinders the gantry from reaching angles ranging between 215° and 325° without damaging the transport fibre. Thus, all other angles were covered using increments of 5 degrees with electron beams. With the detector placed at the isocentre, the irradiation angle corresponds to the Gantry angle. Each calibration curve was then normalized to the deposited dose such as

$${I}_{θ , Calib} = \frac{{x}_{θ , Calib} \times {d}_{C 1}}{200 cGy \times {x}_{C 1}} , \qquad ( 5 )$$

where x_{θ,calib} is the Cerenkov probe signal at a given angle and d_{c1} and x_{c1} are respectively the dose delivered and Cerenkov intensity both measured in dose calibration conditions (i.e., at a depth of dₘₐₓ in a 10×10 cm² field size for a normal incidence). Doses d_{c1} delivered in calibration conditions were validated using the ionization chamber while the 200 cGy was measured using the BCF12 scintillator signal.

### 2.8 Irradiation Angle Measurement Set-Up for Uneven Dose

The ability of the prototype to correctly measure the irradiation angle using both signals was validated by varying simultaneously the dose and irradiation angle. The detector was placed 20 cm below the isocentre in a field size of 40×10 cm² for the photon beams. As the SSD and the off-axis distance vary according to the Gantry position, all irradiation angles provided different mean dose rates, hence a nonconstant dose. The detector being shifted from the isocentre also provided an irradiation angle that differs from the Gantry angle. This ensured that conditions for both dose and irradiation angle were different from the calibration curve measurements. As for the electrons, the 20×20 cm² applicator prevented the phantom to be at an SSD smaller than 97 cm for any angles between 0° and 180°. Accordingly, the detector was placed at the isocentre height. The phantom was instead shifted 8.5 cm toward the X1 jaw direction on the lateral axis as shown in FIG. 4. Irradiations of 200 MU for Gantry angles ranging between 0° and 180° by increments of 5° were performed for all energies and modalities.

FIG. 9 shows schematic top and side views of the set-up used for irradiation angle measurements using photon and electron beams showing the coordinate system. The source-detector distance (SDD) is calculated with the Gantry positioned at 0°.

### 2.9 Irradiation Angle Calculation

The irradiation angle is calculated using a 3-steps process. First step consists of measuring the deposited dose in the Cerenkov sensitive volume at each Gantry angle using the scintillation probe signal. Then, the Cerenkov probe signal (x_{θ}) is normalized to the dose measured by the BCF12 scintillator (d_{θ,scint}) delivered at an irradiation angle θ. This normalization also includes a Cerenkov dose-light calibration factor such as

$${I}_{θ} = \frac{{x}_{θ} \times {d}_{C 1}}{{d}_{θ , scint} \times {x}_{C 1}} , \qquad ( 6 )$$

where d_{c1} and x_{c1} are respectively the dose delivered and Cerenkov intensity obtained by dose calibration measurements. A new dose-light calibration factor is required at each new measurement session to account for any signal losses resulting from the fibre bending, connectors and mechanical and radiation induced damages that could also affect the collected signal. Finally, the Cerenkov angular calibration curve is interpolated using a spline polynomial fit to obtain a calibration function such as

$$f ( θ ) = {I}_{θ , Calib} . \qquad ( 7 )$$

The irradiation angle is obtained by solving the calibration function for the variable θ using the Cerenkov intensity values normalized to the dose (I_{θ}). Due to the symmetry of the Cerenkov angular dependency, one intensity value can have up to four different angles as solutions. Consequently, conditions were set to obtain a single angle value per given intensity. It was assumed that the starting angle and the direction of rotation were both known, and that the latter did not change during an acquisition. Therefore, the first irradiation angle was solved by searching a solution nearby the starting angle. Subsequent angles are solved with the condition of being greater or lesser than the preceding measured angle for clockwise or counterclockwise rotation, respectively.

As the Gantry angles were not equal to the incident angles due to the phantom being shifted from the isocentre, the latter were then calculated for each acquisition using the measurement conditions and set-up geometry. For this calculation, the radiation produced by the target was assumed to be a point source. While the Cerenkov signal intensity is directly linked to the angular distribution of all the electrons above the Cerenkov production threshold energy, the mean incident angle of the primary beam was used to produce the calibration curves. Accordingly, calculated irradiation angles allowed to validate the accuracy of the measured irradiation angles using the hybrid Cerenkov-scintillation detector.

### 2.10 Influence of the Numerical Aperture on the Cerenkov Signal

The effect of the sensitive volume numerical aperture (NA) on the Cerenkov signal collected was investigated using the Detector 2 (see FIG. 1) having a smaller critical angle of 17°. The latter was used to perform intensity measurements of the Cerenkov signal at normal and parallel incidence but also at the peak intensity angle by delivering 200 cGy. For all modalities, signals measured at normal and parallel incidences were normalized to their respective peak intensities. All ratios were then compared to those of the Detector 1, which required no further measurements as they were extracted from the angular calibration curves obtained previously. A complete calibration curve and irradiation angle were also measured with the Detector 2 at 6 MeV in the same manner as described in the preceding sections.

### 3. Results

### 3.1 Signal Unmixing

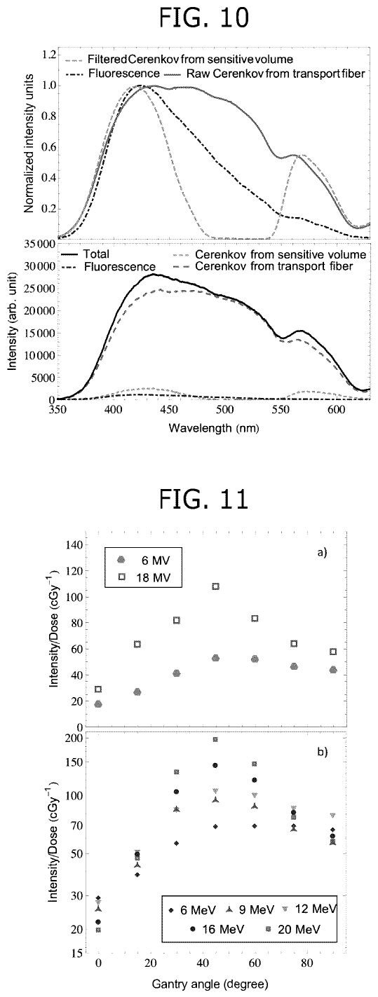

FIG. 10 shows: (a) normalized spectra of each light emitting component of the Cerenkov probe used to perform the signal unmixing; and (b) total intensity measured for a 100 cGy irradiation and individual spectra of each light emitting element of the Cerenkov detector. All spectra are affected by the wavelength response of the photodetection system and the transport fibre transmission spectrum.

The three spectra composing the signal measured by the Cerenkov probe, including the filtered Cerenkov from the sensitive volume as well as the two contamination signals, are shown in FIG. 10.a. The signature shape of the sensitive volume spectrum results from the notch absorptive filter that was chosen to build the prototype. All spectra were normalized to their respective maxima for the purpose of the linear unmixing process.

An example of the Cerenkov probe total intensity measured under a 100 cGy irradiation at normal incidence and the different light emitting source contributions are illustrated in FIG. 10.b. A portion of the total measured spectrum includes some intensity due to fluorescence produced in the transport fibre as the fluorescence to Cerenkov ratio was greater than the calibration measurement conditions. The contribution of the 1 cm long sensitive volume represents only a slight fraction of the total intensity collected as the probe was irradiated with a field size of 10×10 cm².

### 3.2 Dose Linearity, Output Factors and Dose-Rate Independence

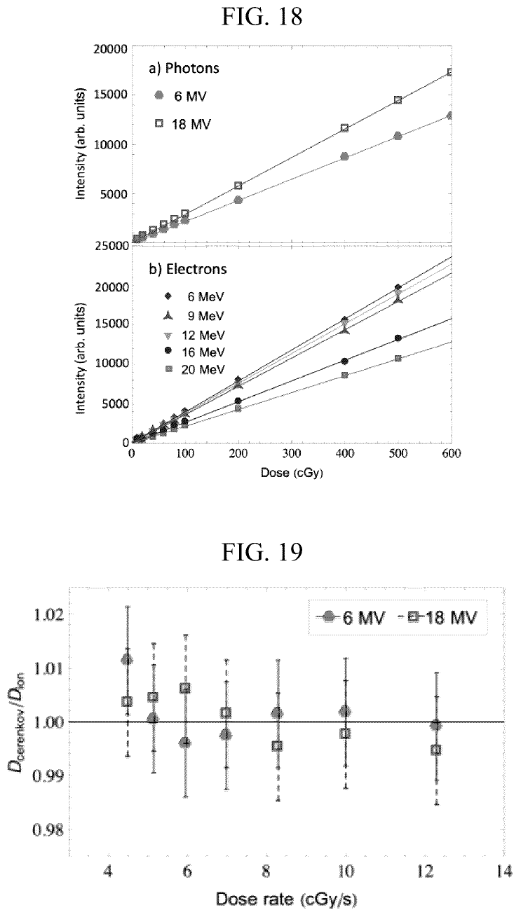

The signal intensity of the Cerenkov sensitive volume was found to follow a linear trend as a function of the dose measured with the scintillation signal for both modalities used. Results obtained for the signal characterization of the Cerenkov probe under 6 and 18 MV photon beams at normal incidence for various doses are shown in FIG. 18.a. Results for the same measurements using 6 to 20 MeV electron beams are presented in FIG. 18.b.

The influence of the energy on the measured intensity was found to vary according to the radiation beam type. While the intensity collected for a given dose tends to increase with energy for the photon beams, an opposite tendency was observed for the electrons. As the Frank-Tamm formula predicts a greater yield with increasing energy, this observation is only valid at normal incidence and the trend at the peak intensity angle should obey the predicted energy dependency.

Compared to ionization chamber measurements, relative output factors were accurately measured within +0.8% using the Cerenkov probe at 6 and 18 MV. The primary particle type did not affect the dose measurements as the Cerenkov detector provided similar accuracy with various electron energies. The average accuracy of the Cerenkov detector is similar to what was observed with the BCF12 detector. Table 1 displays relative output factors obtained with the Cerenkov and the scintillation probes under 6 and 18 MV photon beams while electron beam results are presented in Table 2.

TABLE 1

| | [symbol] | [symbol] | [symbol] | [symbol] | [symbol] | [symbol] |
|---|---|---|---|---|---|---|
| [symbol] | [symbol] | [symbol] | [symbol] | [symbol] | [symbol] | [symbol] |
| 6 MV | 5 [symbol] 5 | 0. [symbol] | 0. [symbol] | 0 [symbol] | 0. [symbol] | 0.2 |
| | 10 [symbol] 10 | 1 | 1 | — | 1 | — |
| | 15 [symbol] 15 | 1.0 [symbol] | 1.0 [symbol] | [symbol] | 1.0 [symbol] | [symbol] 0.1 |
| | 20 [symbol] 20 | 1.0 [symbol] | 1.0 [symbol] | [symbol] | 1.0 [symbol] | 0.2 |
| | 2 [symbol] 2 [symbol] | 1.0 [symbol] | 1.0 [symbol] | [symbol] | 1.9 [symbol] | 0. [symbol] |
| 18 MV | 5 [symbol] 5 | 0. [symbol] | 0. [symbol] | 0. [symbol] | 0. [symbol] | 0. [symbol] |
| | 10 [symbol] 10 | 1 | 1 | — | [symbol] | — |
| | 15 [symbol] 15 | 1.0 [symbol] | 1.0 [symbol] | 0 [symbol] | 1.0 [symbol] | [symbol] 0.1 |
| | 20 [symbol] 20 | 1.0 [symbol] | 1.0 [symbol] | [symbol] 0.03 | 1.0 [symbol] | [symbol] 0.6 |
| | 2 [symbol] 2 [symbol] | | 1.0 [symbol] | [symbol] 0.3 | 1.0 [symbol] | [symbol] 0.2 |

[symbol]

indicates data missing or illegible when filed

TABLE 2

| | [symbol] | [symbol] | [symbol] | [symbol] | [symbol] | [symbol] |
|---|---|---|---|---|---|---|
| [symbol] | [symbol] | [symbol] | [symbol] | [symbol] | [symbol] | [symbol] |
| 6 [symbol] | 6 [symbol] 6 | 0. [symbol] | 0. [symbol] | 0 | 0 [symbol] | 0.3 |
| | 10 [symbol] 10 | 1 | 1 | — | 1 [symbol] | — |
| | 15 [symbol] 15 | 1.00 [symbol] | 1 [symbol] | [symbol] 2 | 1 [symbol] | [symbol] 3 |
| | 20 [symbol] 20 | 1.012 | 1 [symbol] | [symbol] 2 | 1 [symbol] | [symbol] 2 |
| | 2 [symbol] 2 [symbol] | 1.00 [symbol] | 1 [symbol] | [symbol] 2 | 1 [symbol] | [symbol] |
| 9 [symbol] | 6 [symbol] 6 | 0. [symbol] | 0 [symbol] | 0 [symbol] | 0 [symbol] | 0 [symbol] |
| | 10 [symbol] 10 | 1 | 1 | — | 1 | — |
| | 15 [symbol] 15 | 0 [symbol] | 0 [symbol] | [symbol] 3 | 0 [symbol] | [symbol] 3 |
| | 20 [symbol] 20 | 0 [symbol] | 0 [symbol] | [symbol] | 0 [symbol] | [symbol] 3 |
| | 2 [symbol] 2 [symbol] | 0 [symbol] | 0 [symbol] | [symbol] | 0 [symbol] | [symbol] 2 |
| 12 [symbol] | 6 [symbol] 6 | 0 [symbol] | 0 [symbol] | [symbol] 7 | 0 [symbol] | [symbol] 3 |
| | 10 [symbol] 10 | 1 | 1 | — | 1 | — |
| | 15 [symbol] 15 | 0 [symbol] | 0 [symbol] | 0 | 0 [symbol] | 0 |
| | 20 [symbol] 20 | 0 [symbol] | 0 [symbol] | [symbol] | 0 [symbol] | [symbol] 1 |
| | 2 [symbol] 2 [symbol] | 0 [symbol] | 0 [symbol] | [symbol] | 0 [symbol] | [symbol] 2 |
| 16 [symbol] | 6 [symbol] 6 | 0 [symbol] | 0 [symbol] | [symbol] 3 | 0 [symbol] | 0 [symbol] |
| | 10 [symbol] 10 | 1 | 1 | — | 1 | — |
| | 15 [symbol] 15 | 0 [symbol] | 0 [symbol] | [symbol] 2 | 0 [symbol] | 0.1 |
| | 20 [symbol] 20 | 0 [symbol] | 0 [symbol] | [symbol] 1 | 0 [symbol] | 0.3 |
| | 2 [symbol] 2 [symbol] | 0 [symbol] | 0 [symbol] | [symbol] 3 | 0 [symbol] | 0.1 |
| 20 [symbol] | 6 [symbol] 6 | 1.00 [symbol] | 1 [symbol] | [symbol] 2 | 1 [symbol] | 0.3 |
| | 10 [symbol] 10 | 1 | 1 | — | 1 | — |
| | 15 [symbol] 15 | 0 [symbol] | 0 [symbol] | [symbol] | 0 [symbol] | [symbol] 2 |
| | 20 [symbol] 20 | 0 [symbol] | 0 [symbol] | [symbol] 1 | 0 [symbol] | 0 |
| | 2 [symbol] 2 [symbol] | 0 [symbol] | 0 [symbol] | [symbol] 4 | 0 [symbol] | [symbol] 4 |

[symbol]

indicates data missing or illegible when filed

At normal incidence, the measured dose using the Cerenkov sensitive volume signal was found to be dose-rate independent, as expected. For fixed dose irradiations, the sensitive volume signal shows a discrepancy with the predicted dose that reaches 1.1% at 6 MV for the lowest dose rate tested. Similar results were obtained under an 18 MV photon beam and the dose was accurately measured within +0.7%. Dose ratio of the Cerenkov detector to the ionization chamber as a function of the mean dose rate can be found in FIG. 19.

### 3.3 Angular Dependency

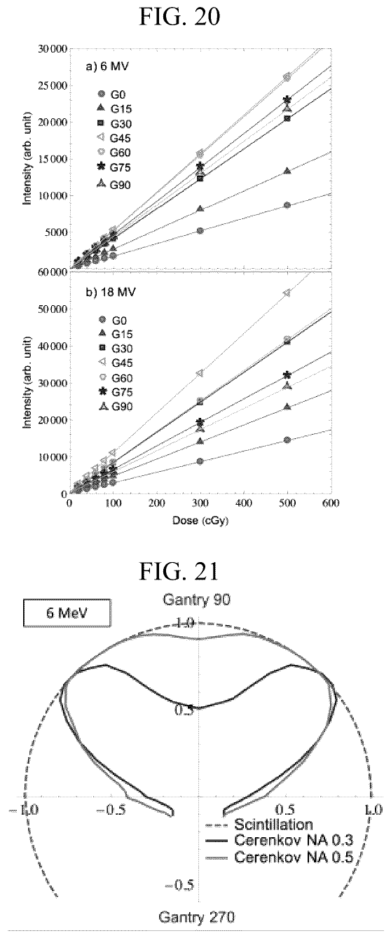

The signal intensity of the Cerenkov probe as a function of the dose measured with the scintillation probe at various angles using two photon beam energies are presented in FIG. 20. While the linear dose-light relationship can be observed for the whole range of angles tested at both energies, the slope of the regression varies based on the irradiation angle due to the Cerenkov angular dependency. Same results were also obtained with the electron beams (not shown). For all Gantry angles and energies tested, the lowest regression slope coefficient of determination was found to be 0.99991.

FIG. 11 shows ratios of a signal emitted by the Cerenkov detector sensitive volume to the deposited dose as a function of the irradiation angle obtained with (a) 6 and 18 MV photon and (b) 6, 9, 12, 16 and 20 MeV electron beams.

The signal intensities of the Cerenkov probe per unit of dose measured with the scintillation probe as a function of the irradiation angle are presented in FIGS. 11.a and 11.b for photon and electron beams, respectively. Comparing the results at various energies shows that the angular dependency also varies as a function of the beam energy. For the photon beams, the intensity per dose unit increases as a function of the energy for all angles. For the electron beams, the intensity collected at normal incidence for a given dose tends to decrease with energy as illustrated in FIG. 11.b. However, the trend at the peak intensity angle obeys the predicted dependency with a greater yield for increasing energy.

### 3.4 Angular Calibration Curve

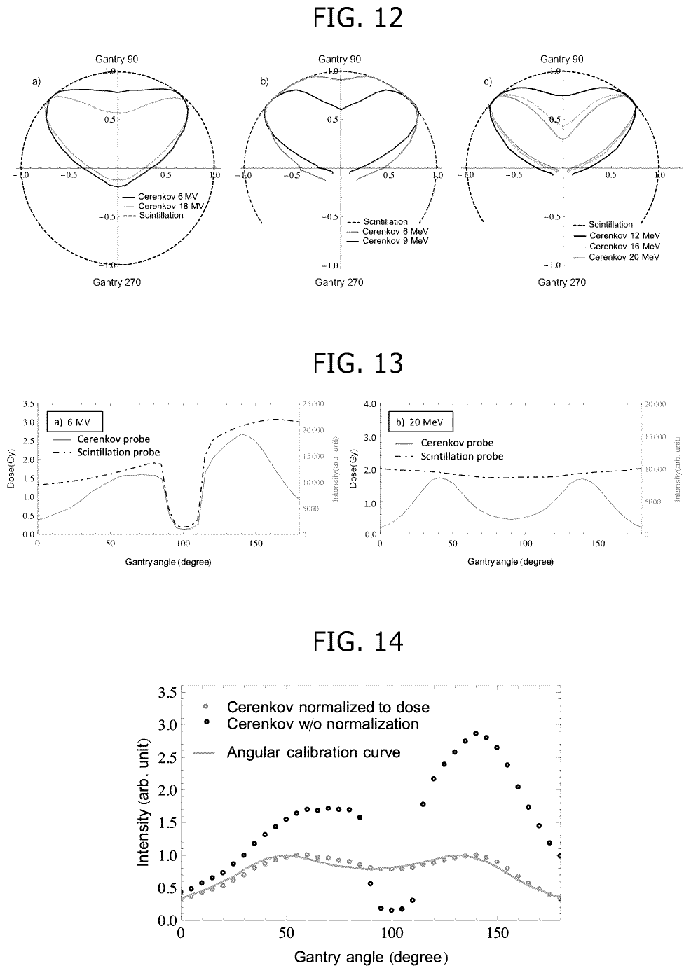

FIG. 12 shows: signal emitted by a Cerenkov detector sensitive volume and the BCF-12 scintillator as a function of the angle of incidence for fixed dose using (a) 6 and 18 MV photon, (b) 6 and 9 MeV and (c) 12, 16 and 20 MeV electron beams. Figure (a) and (c) were obtained using the 6 cm diameter phantom while the 3 cm diameter phantom was used for (b). All signals are normalized to their respective maxima

Signal emitted by the Cerenkov sensitive volume and the scintillator as a function of the irradiation angle for fixed dose are illustrated in FIGS. 12.a, 12.b and 12.c for the various photon and electron beam energies. All signals were normalized to their maxima to emphasize the influence of the beam energy on the angular dependency. For both modalities, the increased beam energy was found to narrow the captured Cerenkov emission cone. Consequently, the 18 MV, 16 and 20 MeV angular calibration curves showed greater slopes at normal incidence and at the peak intensity angle. However, the 9 MeV curve differs from the others as its slope is greater than at 12 MeV. This can be linked to the phantom that is smaller for the 9 MeV beam, thus reducing the scattered electron contribution. Regarding the scintillation (shown by the dashed lines on FIG. 12), the intensity as a function of the angle was found to be isotropic for all modalities due to the absence of angular dependency, as expected.

### 3.5 Cerenkov Intensity for Uneven Doses

Examples of the Cerenkov signal measured as a function of the Gantry angle for uneven doses using 6 MV and 20 MeV beams are presented in FIGS. 13.a and 13.b, respectively. The dose that was measured simultaneously by the scintillator is shown in a blue dashed line. The difference between the two detector signals results from the Cerenkov angular dependency which leads to intensity variations that are not directly linked to the dose deposition. As the acquisition setup was different with the electron beams, the measured dose as a function of the irradiation angle differed from the photon beams. Unfortunately, the dose variation was also limited by the set-up due to the electron applicator.

FIG. 13 shows: interpolated dose measured with the scintillation probe previously dose calibrated and the signal measured by the Cerenkov probe as a function of the Gantry angle using (a) 6 MV photon and (b) 20 MeV electron beams. The Cerenkov signal variations are due to both dose and irradiation angle dependencies.

### 3.6 Irradiation Angle Measurements

FIG. 14 displays an example of the Cerenkov probe intensity normalized to the dose obtained with the scintillation probe at each Gantry position using a 6 MV beam. The Cerenkov intensity without the dose normalization is also included to show the dose dependency effect on the signal. As the Gantry angle does not correspond to the irradiation angle due to the phantom positioning, a shift from the angular calibration curve can be observed, as expected.

FIG. 14 shows Cerenkov intensity measured as a function of the Gantry angle with and without normalization to the dose measured by the scintillator at 6 MV. The calibration curve is also included for comparison. Each point corresponds to an individual measurement.

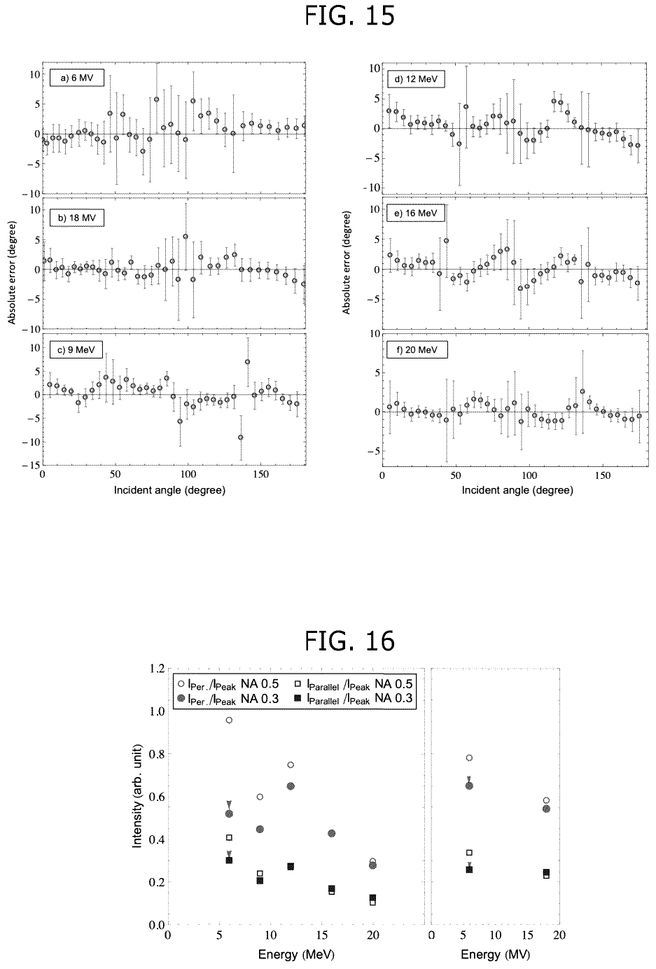

The irradiation angle absolute errors obtained by solving the calibration function with the Cerenkov signal normalized to the dose are presented in FIG. 15 for the photon and electron beams. The difference was obtained by using the real incident angle calculated with the set-up geometry and the source position. Irradiation angle measurements exhibit an absolute mean error of 1.86° and 1.02° at 6 and 18 MV, respectively, as shown in FIGS. 15.a and 15.b. Similar results were obtained with the four different electron beam energies as depicted in FIGS. 15.c, 15.d, 15.e and 15.f. The absolute mean error reaches 1.97°, 1.66°, 1.45° and 0.95° at 9, 12, 16 and 20 MeV, respectively. For the photon beams, the lowest doses are linked to the highest differences observed while the latter were located around the peak intensity angle for the electron beams. A repetitive structure in the absolute error plots resulting from the four subfunctions defining the piecewise polynomial fit can be observed. For all measurements, error bars were calculated using the mean error on the Cerenkov signal intensity.

FIG. 15 shows: angle of incidence absolute error measured with the Cerenkov detector using a dose varying as a function of the irradiation angle for a) 6 MV and b) 18 MV photon beams and (c) 9 MeV, (d) 12 MeV, (e) 16 MeV and (f) 20 MeV electron beams.

### 3.7 Numerical Aperture Influence

Signal of the two different Cerenkov probes at normal and parallel incidences normalized to their respective peak intensities are depicted in FIG. 16. While the decreased numerical aperture was found to have little influence on the collected intensity ratios at high energies, a pronounced effect at lower energies can be observed. For both modalities, ratios at normal and parallel incidences at the lowest energies were significantly reduced with the probe having a NA of 0.3 compared to the 0.5.

FIG. 16 shows ratios of the Cerenkov sensitive volume signal measured at parallel and normal incidence to the peak intensity as a function of the energy using the two detectors with numerical aperture of 0.3 and 0.5.

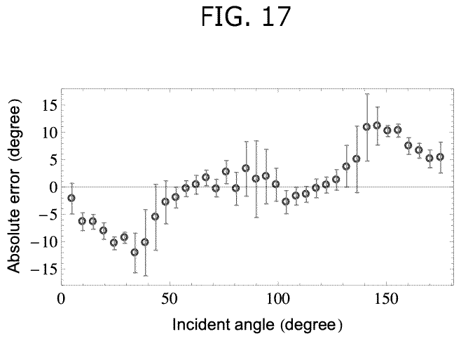

Angular calibration curves of a 6 MeV beam with both Cerenkov probes have demonstrated that reducing the NA emphasizes the angular dependency (see FIG. 21). Narrowing of the fibre acceptance cone has lessened the portion of the captured Cerenkov emission cone, therefore enhancing the slope of the curve. Thus, irradiation angle measurements at 6 MeV are now possible with Detector 2. It yields a mean absolute error of 4.82°, with the distribution as function of angle of incidence illustrated in FIG. 17. Discrepancies can be seen around the peak intensity values similarly to the other electron energies. However, the Cerenkov detector using a 6 MeV beam misrepresents all angles measured below 40° and above 140°.

FIG. 17 shows the angle of incidence absolute error measured with the Cerenkov detector (NA=0.3) using a dose varying as a function of the irradiation angle for 6 MeV.

### 4. Discussion

### 4.1 Cerenkov Probe Dose-Light Relationship

Characterization of the relationship between the Cerenkov probe sensitive volume signal collected and the deposited dose is of great interest to validate the suitability of the detector. As the Cerenkov probe was used in the same manner as a PSD at first, it allowed to validate the proportionality of the Cerenkov signal and the dose for all modalities and energies tested. While there is no direct dependency between the two of them, they both share an electron energy spectrum dependency. Due to this dependency of the Cerenkov yield, the capture and transmission along the fibre are affected by the depth of measurement. As electron energy loss increases with the travelled distance, the slowing-down process induces fewer Cerenkov photons with lower angle between the fibre axis and the particle path due to the narrowing of the cone opening. However, results showed that using calibration conditions where the electron energy spectrum is identical to the measurement conditions allows to rely on deposited dose to account for this dependency.

### 4.2 Contamination Signal Influence

The accuracy of output factor measurements using the Cerenkov probe is investigated and a comparison is conducted with the scintillator for a wide range of field sizes. The reason for this test was to compare the efficiency of the Cerenkov signal separation method as the contamination signal increases. While the algorithm worked properly for a constant contamination to sensitive volume signal ratio, it was necessary to validate that an increase of the contamination signal resulting from larger field sizes would not affect the Cerenkov probe accuracy. It was found that both detectors provide similar accuracy for all field sizes and modalities tested. This result is a pre-requisite as the dose measured by the scintillation detector is intended to eliminate the electron energy spectrum dependency of the Cerenkov signal. Furthermore, the dose rate independence measurements were also conducted with increasing field size as a function of the SSD. While the dose was accurately measured within +0.8% with the Cerenkov probe at 18 MV, a greater difference was observed with the 6 MV beam at the lowest dose rate. This discrepancy arises from the total signal that decreases as the electron fluence is reduced for larger SSD.

### 4.3 Energy and Angular Dependency

The nominal energy of the beam has shown to influence the total intensity collected as a function of dose. In agreement with the Frank-Tamm formula, the 18 MV beam induced a greater amount of Cerenkov light in the sensitive volume than at 6 MV. At the peak intensity, that is approximately twice the number of optical photons for a given dose that are collected using the 18 MV beam. Moreover, the intensity per Gy as a function of the irradiation angle was also found to vary according to energy. The most significant differences between the 6 and 18 MV beam measurements can be observed for gantry angles ranging between 45° and 90° (FIG. 11). While a greater variation of intensity per dose unit as a function of the irradiation angle can be observed at 18 MV for this interval, the regression slope values obtained at 6 MV only showed minor changes. This results from the increase of electrons having lower energy which consequently shifts the angular dependency toward lower angles between the fibre axis and the particle paths. Thus, it allows more of the Cerenkov cone to be captured. The difference between the angular dependency of the two energies further arises from the particle paths. In fact, the secondary electrons resulting from Compton effect at higher energies tends to be scattered forward (Andreo et al 2017). Accordingly, the Cerenkov angular dependency at 18 MV will be increased as the particle paths better reflects the irradiation angle.

For the electron beams, measurements performed at normal incidence shows that the intensity collected per dose unit declines as a function of the energy. This is counter-intuitive as the Cerenkov yield is supposed to increase with energy according to Frank-Tamm formula. This irregularity at normal incidence is also attributable to the electron paths that tend to go forward at higher energies. Contrarily, lower energy beam provides numerous electrons with arbitrary trajectories that are not related anymore to the beam incident angle. Thus, the Cerenkov angular distribution is broader, and it increases the amount of light reaching the detector at lower angles. Inversely, the signal at higher energies decreases due to the narrowing of the Cerenkov cone. At the peak intensity angle, the 20 MeV beam induced a greater amount of Cerenkov light in the sensitive volume in agreement with the predicted Cerenkov yield. Nonetheless, due to the important variations of the intensity per dose unit as a function of the beam energy for both modalities, a calibration must be performed for each of them to enable the use of the detector for dose or angle measurements.

### 4.4 Irradiation Angle Measurements

The angular dependency of the Cerenkov probe was proven to be a suited tool for irradiation angle measurements. The technique developed in the present study to account for the Cerenkov signal variations attributable to the electron energy spectrum dependency using the deposited dose was found to provide appreciable results. As plastic scintillation detectors have already proven their ability to perform accurate dosimetric measurements, the hybrid detector can rely on the scintillator for dose measurements necessary for irradiation angle measurements. Although most of the angle errors fall within the tolerance imposed by the Cerenkov intensity mean error, few outliers can be seen at all energies. For the photon beams, they correspond to the lowest doses and dose rates arising from the phantom positioning. Accordingly, the total signal collected was relatively low compared to the angular calibration curve. This resulted in higher discrepancies as the accuracy is closely related to the Cerenkov sensitive volume signal intensity. Also, the dose-light calibration factor obtained before irradiation angle measurements showed that the fibre has suffered a 47% signal drop since its first use. Combination of the fibre bending, connectors, mechanical damages and radiation induced damages from a total dose reaching over 4 kGy have resulted in signal transmission losses. Therefore, a new prototype and an improved connection and bending reproducibility would increase the signal and the detector accuracy.

As for the electron beams, the poor angular dependency of the 6 MeV beam has prevented this energy to be used with the first prototype. Since intensities collected at many angles are identical, the algorithm could not properly calculate the irradiation angle with the conditions imposed and provided an infinite number of solutions. For other energies, outliers lie around the peak intensity angle. Since the calibration curves were performed for Gantry angles with increment of 5 degrees, an interpolation was required to obtain a continuous curve. Thus, the calibration curves at angles where the slope changes drastically, such as the peak intensity angle and normal incidence, could be imprecise and therefore causes some of the outliers. Accordingly, a thorough angular calibration curve and signal optimization of the detector could significantly improve the detector performances.

### 4.5 Numerical Aperture

The numerical aperture was found to affect the angular dependency of the lowest energy beams by reducing the portion of the Cerenkov emission cone captured for both modalities. As the angular distribution of the Cerenkov decreases at higher energy, the acceptance cone of the optical fibre has less impact on the Cerenkov capture. While the irradiation angles could be measured accurately with the detector placed in the central portion of the beam profile at 6 MeV, an increasing off-axis distance has led to higher discrepancies reaching up to 12°. This can be attributable to an important variation in the electron energy spectrum resulting from an increased contribution of scattered electrons compared to the calibration measurements. The penumbra region being wider for low energy beams, this effect is less perceptible for other electron beams used in this study. Moreover, electrons of approximately 1 MeV or less reduce significantly the Cerenkov emission angle (Law et al 2006). Consequently, a smaller numerical aperture will have a greater impact on the captured Cerenkov emission for angles approaching normal incidence, which coincides with the greatest off-axis distance in the set-up used for irradiation angle measurements. Due to the complexity of field geometries in patient treatment plans, this limitation of the detector is more likely to prevent its usage with a 6 MeV beam unless a calibration method can account for the electron energy spectrum variations.

### 5. Conclusion

Using a first prototype of a Cerenkov-scintillation detector, the Cerenkov dose-light relationship for fixed angle measurements was validated for 6 and 18 MV photon and 6 to 20 MeV electron beams. Output factors were accurately measured within +0.8% for field size up to 25×25 cm² for all energies tested with both photons and electrons. The average accuracy is similar to what was observed with the BCF12 detector.

The ability to perform simultaneous dose and irradiation angle measurements of external photon and electron beams was also shown. The irradiation angle measurements ranging between 0û and 180û revealed an absolute mean error of 1.86° and 1.02° at 6 and 18 MV, respectively. The accuracy of the detector was also similar while using four different electron beam energies. The absolute mean error was respectively of 1.97°, 1.66°, 1.45° and 0.95° at 9, 12, 16 and 20 MeV. As for the 6 MeV beam irradiation angle measured with the detector having a smaller numerical aperture, the absolute mean error reaches 4.82°. While also measuring the deposited dose, the hybrid Cerenkov-scintillation detector provides useful additional information that other conventional dosimeters are unfit to measure.

First results offer promising perspectives for future applications in external beam radiotherapy, especially for stereotactic radiosurgery (SRS) and magnetic resonance image-guided radiotherapy (MR-IGRT). Moreover, its applications could be extended to brachytherapy treatments as part of a source tracking device. This avenue will be explored in future work.

The various embodiments described herein have been provided as examples only. It should be understood that various modifications in form and detail can be made to the embodiments described and illustrated herein, without departing from the appended claims.

### REFERENCES

Alexander D A, Zhang R, Brůža P, Pogue B W and Gladstone D J 2020 Scintillation imaging as a high-resolution, remote, versatile 2D detection system for MR-linac quality assurance Med Phys 47 3861-9.
Andreo P, Burns D T, Nahum A E and Seuntjens J 2017 Fundamentals of Ionizing Radiation Dosimetry: Solutions to the Exercises (Weinheim: John Wiley & Sons).
Archambault L, Beddar A S, Gingras L, Roy R and Beaulieu L 2006 Measurement accuracy and cerenkov removal for high performance, high spatial resolution scintillation dosimetry Med Phys 33 128-35.
Archambault L, Therriault-Proulx F, Beddar S and Beaulieu L 2012 A mathematical formalism for hyperspectral, multipoint plastic scintillation detectors Phys. Med. Biol. 57 7133-45.
Beaulieu L and Beddar S 2016 Review of plastic and liquid scintillation dosimetry for photon, electron, and proton therapy Physics in Medicine and Biology 61 R305-43.
Beddar A S, Mackie T R and Attix F H 1992 Cerenkov light generated in optical fibres and other light pipes irradiated by electron beams Phys. Med. Biol. 37 925-35.
Benedict S H, Cai J, Libby B, Lovelock M, Schlesinger D, Sheng K and Yang W 2010 SRT and SBRT: Current practices for QA dosimetry and 3D J. Phys.: Conf. Ser. 250 012057.
Boer S F de, Beddar A S and Rawlinson J A 1993 Optical filtering and spectral measurements of radiation-induced light in plastic scintillation dosimetry Phys. Med. Biol. 38 945-58.
Cherenkov P A 1934 Visible Emission of Clean Liquids by Action of y Radiation Dokl. Akad. Nauk SSSR 2 451.
Cumalat J P, Cheung H W K, Hassed J, Smith B D and Bross A D 1990 Effects of magnetic fields on the light yield of scintillators.
Nuclear Instruments and Methods in Physics Research Section A: Accelerators, Spectrometers, Detectors and Associated Equipment 293 606-14.
Elith C, Dempsey S E, Findlay N and Warren-Forward H M 2011 An Introduction to the Intensity-modulated Radiation Therapy (IMRT) Techniques, Tomotherapy, and VMAT Journal of Medical Imaging and Radiation Sciences 42 37-43.
Ezzell G A, Galvin J M, Low D, Palta J R, Rosen I, Sharpe M B, Xia P, Xiao Y, Xing L, Yu C X, IMRT subcommitte, and AAPM Radiation Therapy committee 2003 Guidance document on delivery, treatment planning, and clinical implementation of IMRT: report of the IMRT Subcommittee of the AAPM Radiation Therapy Committee Med Phys 30 2089-115.
Frelin A M, Fontbonne J M, Ban G, Colin J, Labalme M, Batalla A, Isambert A, Vela A and Leroux T 2005 Spectral discrimination of Cerenkov radiation in scintillating dosimeters Med Phys 32 3000-6.
Glaser A K, Davis S C, Voigt W H A, Zhang R, Pogue B W and Gladstone D J 2013 Projection imaging of photon beams using Čerenkov-excited fluorescence Phys Med Biol 58 601-19.
Glaser A K, Zhang R, Gladstone D J and Pogue B W 2014 Optical dosimetry of radiotherapy beams using Cherenkov radiation: the relationship between light emission and dose Phys. Med. Biol. 59 3789-811.
Guillot M, Gingras L, Archambault L, Beddar S and Beaulieu L 2011 Spectral method for the correction of the Cerenkov light effect in plastic scintillation detectors: A comparison study of calibration procedures and validation in Cerenkov light-dominated situations Med Phys 38 2140-50.
Hachadorian R L, Bruza P, Jermyn M, Gladstone D J, Pogue B W and Jarvis L A 2020 Imaging radiation dose in breast radiotherapy by X-ray CT calibration of Cherenkov light Nature Communications 11 2298.
Jang K W, Yagi T, Pyeon C H, Yoo W J, Shin S H, Jeong C, Min B J, Shin D, Misawa T and Lee B 2013 Application of Cerenkov radiation generated in plastic optical fibers for therapeutic photon beam dosimetry JBO 18 027001.
Jean E, Therriault-Proulx F and Beaulieu L 2021 Comparative optic and dosimetric characterization of the HYPERSCINT scintillation dosimetry research platform for multipoint applications Phys. Med. Biol. 66 085009.
Jelen U and Begg J 2019 Dosimetry needs for MRI-linacs J. Phys.: Conf. Ser. 1305 012010.
Jelley J V 1958 Cerenkov Radiation And Its Applications (Norwich: Pergamon Press).
Konefał A, Bakoniak M, Orlef A, Maniakowski Z and Szewczuk M 2015 Energy spectra in water for the 6 MV X-ray therapeutic beam generated by Clinac-2300 linac Radiation Measurements 72 12-22.
Lambert J, Yin Y, Mckenzie D R, Law S and Suchowerska N 2008 Cerenkov-free scintillation dosimetry in external beam radiotherapy with an air core light guide Phys. Med. Biol. 53 3071-80.
Law S H, Fleming S C, Suchowerska N and Mckenzie D R 2006 Optical fiber design and the trapping of Cerenkov radiation Appl Opt 45 9151-9.
Law S H, Suchowerska N, Mckenzie D R, Fleming S C and Lin T 2007 Transmission of Čerenkov radiation in optical fibers Opt. Lett., OL 32 1205-7.
Liney G and Heide U van der 2019 MRI for Radiotherapy: Planning, Delivery, and Response Assessment (New York: Springer International Publishing).
Liu P Z Y, Suchowerska N, Lambert J, Abolfathi P and Mckenzie D R 2011 Plastic scintillation dosimetry: comparison of three solutions for the Cerenkov challenge Phys. Med. Biol. 56 5805-21.
Madden L, Archer J, Li E, Jelen U, Dong B, Roberts N, Holloway L and Rosenfeld A 2019 First measurements with a plastic scintillation dosimeter at the Australian MRI-LINAC Phys. Med. Biol. 64 175015.
Mclaughlin D J, Hogstrom K R, Neck D W and Gibbons J P 2018 Comparison of measured electron energy spectra for six matched, radiotherapy accelerators Journal of Applied Clinical Medical Physics 19 183-92.
Meng X, Du Y, Li Z, Zhu S, Wu H, Li C, Chen W, Nie S, Ren Q and Lu Y 2019 Cherenkov Radiation Induced by Megavolt X-Ray Beams in the Second Near-Infrared Window Optics Communications 452 417-21.
Meyer J 2011 IMRT, IGRT, SBRT: Advances in the Treatment Planning and Delivery of Radiotherapy (Basel: Karger Medical and Scientific Publishers).
Nowotny R 2007 Radioluminescence of some optical fibres Phys. Med. Biol. 52 N67-73.
O'Brien D J, Dolan J, Pencea S, Schupp N and Sawakuchi G O 2018 Relative dosimetry with an MR-linac: Response of ion chambers, diamond, and diode detectors for off-axis, depth dose, and output factor measurements Med Phys 45 884-97.
Pogue B W, Glaser A K, Zhang R and Gladstone D J 2015 Cherenkov radiation dosimetry in water tanks—video rate imaging, tomography and IMRT & VMAT plan verification Journal of Physics: Conference Series 573 012013.
Solberg T D, Balter J M, Benedict S H, Fraass B A, Kavanagh B, Miyamoto C, Pawlicki T, Potters L and Yamada Y 2012 Quality and safety considerations in stereotactic radiosurgery and stereotactic body radiation therapy: Executive summary Practical Radiation Oncology 2 2-9.
Tamm I E and Frank I M 1937 Coherent radiation of afast electron in a medium Dokl. Akad. Nauk SSSR 14 107-12.
Tendler I I, Hartford A, Jermyn M, LaRochelle E, Cao X, Borza V, Alexander D, Bruza P, Hoopes J, Moodie K, Marr B P, Williams B B, Pogue B W, Gladstone D J and Jarvis L A 2020 Experimentally Observed Cherenkov Light Generation in the Eye During Radiation Therapy International Journal of Radiation Oncology*Biology*Physics 106 422-9.
Therriault-Proulx F, Beaulieu L, Archambault L and Beddar S 2013 On the nature of the light produced within PMMA optical light guides in scintillation fiber-optic dosimetry Phys Med Biol 58 2073-84.
Therriault-Proulx F, Wen Z, Ibbott G and Beddar S 2018 Effect of magnetic field strength on plastic scintillation detector response Radiation Measurements 116 10-3.
Yogo K, Matsushita A, Tatsuno Y, Shimo T, Hirota S, Nozawa M, Ozawa S, Ishiyama H, Yasuda H, Nagata Y and Hayakawa K 2020 Imaging Cherenkov emission for quality assurance of high-doserate brachytherapy Scientific Reports 10 3572.
Yoo W J, Shin S H, Jeon D, Hong S, Kim S G, Sim H I, Jang K W, Cho S and Lee B 2013 Simultaneous measurements of pure scintillation and Cerenkov signals in an integrated fiber-optic dosimeter for electron beam therapy dosimetry Opt. Express, OE 21 27770-9.
Zhang X, Qiu J, Li X, Zhao J and Liu L 2020 Complex refractive indices measurements of polymers in visible and near-infrared bands Appl. Opt., AO 59 2337-44.
Zlateva Y, Muir B R, El Naqa I and Seuntjens J P 2019a Cherenkov emission-based external radiotherapy dosimetry: I. Formalism and feasibility Med Phys 46 2370-82.
Zlateva Y, Muir B R, Seuntjens J P and El Naqa I 2019b Cherenkov emission-based external radiotherapy dosimetry: II. Electron beam quality specification and uncertainties Med Phys 46 2383-93.

1. A detector, comprising:
a sensing volume of Cerenkov generating material, configured to sense charged particles with different angles and energies in response to irradiation and to emit a spectral and angular distribution of Cerenkov optical light indicative of an angular and energy distribution of incoming charged particles sensed by the volume of Cerenkov generating material.

2. The detector of the preceding claim, comprising:
a probe, wherein the sensing volume of Cerenkov generating material is positioned inside the probe.

3. A detector, comprising:
at least one sensing volume of Cerenkov generating material, configured to sense charged particles with different angles and energies in response to irradiation and to emit a spectral and angular distribution of Cerenkov optical light in one or more regions of an optical spectrum, the Cerenkov optical light being indicative of angular and energy distribution of charged particles sensed by the volume of Cerenkov generating material; and
at least one optical guide optically coupled to the at least one sensing volume of Cerenkov generating material and configured to provide an output signal indicative of the Cerenkov optical light.

4. The detector of any one or more of the preceding claims, further comprising an isolating element configured to isolate the Cerenkov optical light of the at least one sensing volume of Cerenkov generating material from any other contaminating optical signal.

5. The detector of any one or more of the preceding claims, wherein the isolating element comprises an optical filter, a hollow-core light guide or a Cerenkov generating material with a specific transmission spectrum.

6. The detector of any one or more of the preceding claims, wherein the isolating element has minimal reflection for preventing optical energy to reflect towards an emission source.

7. The detector of any one or more of the preceding claims, wherein the isolating element has minimal angle sensitivity, so that light can be incident upon the filter from a wide range of angles and the filter will maintain its transmission, absorption and reflection spectral and intensity properties.

8. The detector of any one or more of the preceding claims, further comprising one or more radio-luminescent elements configured to generate radio-luminescent optical signal in one or more regions of an optical spectrum.

9. The detector of any one or more of the preceding claims, wherein the at least one optical guide is configured to receive the radio-luminescent optical signal from the one or more radio-luminescent elements.

10. The detector of any one or more of the preceding claims, wherein the at least one optical guide is selected such that the radio-luminescent optical signal from the one or more radio-luminescent elements has optical spectra significantly different from the optical spectrum of the Cerenkov optical light from the at least one sensing volume of Cerenkov generating material.

11. The detector of any one or more of the preceding claims, wherein the at least one optical guide is configured to minimize emission of a contamination signal.

12. The detector of any one or more of the preceding claims, further comprising a photodetection module optically coupled to the at least one light guide and configured to measure an intensity of the Cerenkov optical light as a function of different spectral ranges.

13. The detector of any one or more of the preceding claims, wherein the photodetection module is further configured to measure an intensity of the radio-luminescent optical signal as a function of different spectral ranges.

14. The detector of any one or more of the preceding claims, further comprising a spectral module optically coupled to the at least one optical guide and configured to receive and spectrally decouple different regions of the Cerenkov optical light.

15. The detector of any one or more of the preceding claims, wherein the spectral module is configured to receive and spectrally decouple different regions of the radio-luminescent optical signal.

16. The detector of any one or more of the preceding claims, wherein the at least one sensing volume of Cerenkov generating material and the one or more radio-luminescent elements are contiguous and/or concentric.

17. The detector of any one or more of the preceding claims, wherein the at least one sensing volume of Cerenkov generating material and the one or more radio-luminescent elements are arranged in a linear configuration, a two-dimensional planar configuration or a three-dimensional configuration.

18. The detector of any one or more of the preceding claims, wherein the volume of Cerenkov generating material comprises any one of: poly-methyl-methacrylate (PMMA); polystyrene (PS); polyvinyl toluene (PVT), or silica.

19. The detector of any one or more of the preceding claims, wherein the one or more radio-luminescent elements comprise a single or multi-point scintillation detector, scintillating fibers, or a fluorescent material.

20. The detector of any one or more of the preceding claims, further comprising a probe wherein the at least one sensing volume of Cerenkov generating material and/or the one or more radio-luminescent elements are positioned within the probe.

21. The detector of any one or more of the preceding claims, wherein the at least one light guide is a single optical guide having no significant contamination signal.

22. The detector of any one or more of the preceding claims, further comprising a computing device, optionally coupled to the photodetection module and/or the spectral module, and configured to receive and process electrical signals from the photodetection module and/or the spectral module to compute a measured radiation dose and an irradiation angle based on the measured intensity of Cerenkov optical light and/or the measured radio-luminescent signal.

23. A method for determining a metric correlated to one or more Cerenkov signal dependencies from a given Cerenkov-generating material, comprising:
sensing charged particles with different angles and energies using a Cerenkov-generating material;
emitting Cerenkov optical light within the Cerenkov-generating material indicative of angular distribution of the charged particles, energy distribution of the charged particles, and deposited radiation dose;
measuring the intensity of a composed optical signal, comprised of Cerenkov optical light from the Cerenkov generating material and other contaminating signals, as a function of one or more regions of the optical spectrum;
isolating the Cerenkov optical light from any other contaminating signal;
determining a contribution of the Cerenkov optical light emitted by the Cerenkov-generating material to the composed optical signal; and
determining a metric based on the contribution and correlated to the angular distribution of charged particles, energy distribution of charged particles or radiation dose.

24. The method of the preceding claim wherein the one or more Cerenkov signal dependencies comprises any one of: an angular distribution of charged particles, an energy distribution of charged particles, and radiation dose.

25. The method of any one or more of the preceding claims further comprising sensing at least one radio-luminescent optical signal with at least one radio-luminescent element proximate to the Cerenkov-generating material.

26. The method of the preceding claim further comprising modulating the Cerenkov optical light and/or the radio-luminescent optical signal from the at least one radio-luminescent element such that the radio-luminescent optical signal has optical spectra different from the optical spectrum of the Cerenkov optical light.

27. The method of the preceding claim wherein the isolation step comprises modulating the Cerenkov optical light coming from the Cerenkov-generating material such that it has an optical spectrum different from any other optical signal that are part of the composed optical signal.

28. The method of the preceding claim further comprising, minimizing contamination of the Cerenkov optical light coming from the Cerenkov-generating material and/or the radio-luminescent optical signal.

29. The method of any one or more of the preceding claims, wherein the volume of Cerenkov generating material comprises: poly-methyl-methacrylate (PMMA); polystyrene (PS); polyvinyl toluene (PVT); or silica.

30. The method of the preceding claim, wherein the radio-luminescent element comprises a scintillator, a scintillating fiber, a fluorescent material, or a phosphorescent material.

31. The method of any one or more of the preceding claims, further comprising removing or accounting for a first dependency of the contribution of the Cerenkov optical light emitted by the Cerenkov-generating material to the composed optical signal.

32. The method of the preceding claim, wherein the first dependency comprises any one of: a radiation dose; a charged-particles distribution angle; and a Cerenkov-generating charged particle energy spectrum.

33. The method of the preceding claim further comprising obtaining the first dependency with any one of: a scintillation detector; a treatment planning system; Monte Carlo simulations; a dose detector; a plastic scintillation detector; a diode; an ionizing chamber; and a diamond detector.

34. The method of any one or more of the preceding claims further comprising obtaining the first dependency based on the at least one radio-luminescent element proximate to the Cerenkov-generating material.

35. The method of the preceding claim further comprising keeping a distribution of the first dependency similar between measurement and calibration conditions.

36. The method of the preceding claim, further comprising removing or accounting for a second dependency of the contribution of the Cerenkov optical light emitted by the Cerenkov-generating material to the composed optical signal.

37. The method of the preceding claim, wherein the second dependency comprises any one of: a radiation dose; a charged-particles distribution angle; and a Cerenkov-generating charged particle energy spectrum.

38. The method of the preceding claim further comprising obtaining the second dependency with any one of: a scintillation detector; a treatment planning system; Monte Carlo simulations; a dose detector; a plastic scintillation detector; a diode; an ionizing chamber; and a diamond detector.

39. The method of any one or more of the preceding claims further comprising obtaining the second dependency based on the at least one radio-luminescent element proximate to the Cerenkov-generating material.

40. The method of the preceding claim further comprising keeping distribution of the second dependency similar between measurement and calibration conditions.

41. The method of any one or more of the preceding claims, further comprising correlating the resulting Cerenkov optical light from the Cerenkov generating material to the change in the irradiation conditions to which the sensing volume of Cerenkov generating material is subjected to.

42. The method of any one or more of the preceding claims, further comprising correlating the resulting Cerenkov optical light with a gantry angle, tracking a radiation source position, or evaluating magnetic field impact on electron trajectory.

43. A method for determining metrics correlated to one or more Cerenkov signal dependencies from multiple Cerenkov-generating materials, comprising:
sensing charged particles with different angles and energies using multiple Cerenkov-generating materials;
emitting Cerenkov optical light within the multiple Cerenkov-generating materials indicative of angular distribution of the charged particles, energy distribution of the charged particles, and deposited radiation dose at each of the multiple Cerenkov-generating materials;
measuring the intensity of at least one composed optical signal, comprised of Cerenkov optical light from at least one Cerenkov generating material and other contaminating signals, as a function of one or more regions of the optical spectrum;
isolating the Cerenkov optical light from any other contaminating signal;
determining a contribution of the Cerenkov optical light emitted by the at least one Cerenkov-generating material to the associated composed optical signal; and
determining a metric based on the contribution correlated to the angular distribution of charged particles, energy distribution of charged particles or radiation dose for each of the Cerenkov-generating materials.
